(19) United States
(12) Patent Application Publication
(10) Pub. No.: US 2011/0099054 A1
(43) Pub. Date: Apr. 28, 2011

(54) HUMAN BEHAVIOR ANALYSIS SYSTEM

(75) Inventors: Norihiko Moriwaki, Hino (JP); Kazuo Yano, Hino (JP); Nobuo Sato, Saitama (JP); Satomi Tsuji, Kokubunji (JP); Koji Ara, Higashiyamato (JP)

(73) Assignee: HITACHI, LTD., Tokyo (JP)

(21) Appl. No.: 12/993,551

(22) PCT Filed: May 26, 2009
(86) PCT No.: PCT/JP2009/059601

§ 371 Date: Nov. 19, 2010

(30) Foreign Application Priority Data
May 26, 2008 (JP) 2008-136187

(51) Int. Cl. G06Q 10/00

(52) U.S. Cl. 705/7.41; 705/7.11

(57) ABSTRACT

In an organization dynamics analysis service using a sensor, organization dynamics information is understandably provided to a lot of members on a customer side without receiving private information such as an individual name from the customer. Therefore, a sensor data associated with an ID is received from the customer site, and organization analysis is performed on a service provider side, and then, an organization analysis data based on the ID is fed back to the customer site. When the customer browses the organization analysis data, the ID is converted into the private information in a service gateway installed on the customer site in accordance with a conversion table for correspondence of the ID previously specified on the customer side and the private information (individual name), and is shown to the customer as the understandable information.

### TECHNICAL FIELD

The present invention relates to a business microscope system acquiring a communication data of a person and visualizing a state of an organization. More particularly, the present invention relates to a system of achieving a service of acquiring sensor data from a sensor worn on workers of a customer, analyzing organization dynamics, and providing an analyzed result to the customer.

### BACKGROUND ART

In developed countries, improvement of job productivity of a white-collar worker called an intellectual worker is a significant task. In a manufacturing field such as a factory, products in a productive field are visible, and therefore, it is easy to eliminate useless jobs not related to the productivity. On the other hand, in a white-collar organization performing intellectual works such as a research and development division, planning division, and sales division, the definition of results which are their products is not easy, and therefore, it is difficult to eliminate useless jobs unlike the manufacturing field. Also, for improvement of the white-collar job productivity as represented by a project organization, a system of maximally using not only an individual ability but also cooperative relationship among a plurality of members is required. In order to promote these white-collar jobs, communication among the members is important. By the communication among the members, the understanding of each other is enhanced and their feeling of trust is caused, so that motivations of the members are increased, and as a result, a goal of the organization can be achieved.

As one method of detecting communication between one person and the other person, a technique called sensor net can be utilized. The sensor net is a technique applied to acquiring and controlling a state by wearing a small-size computer node (terminal) having a sensor and a wireless communication circuit to environment, an object, a person, or others, and retrieving various information obtained from the sensor with the wireless communication. As a sensor aiming at detection of the communication among the members in the organization, there are an infrared sensor for detection of a face-to-face state among the members, a voice sensor for detection of their conversation or environment, and an acceleration sensor for detection of human movement.

As a system of detecting the state of the communication among the members in the organization or movements of the members from physical quantity obtained by these sensors to quantify and visualize organization dynamics which cannot be conventionally visualized, there is a system called business microscope (registered). In the business microscope, it is known that the dynamics of the organization communication can be visualized by the face-to-face information among the members in the organization.

In order to achieve an organization analysis service utilizing the business microscope system, a method shows promise, in which a service provider collects an organization data of a target customer from the organization, and diagnosed and analyzed results for the organization state is fed back to the customer side. And, in order to achieve the organization analysis service utilizing the business microscope system, private information on the customer side is treated.

As a method of providing the service by another provider without treating the private information, a method is known, in which the service provider performs transaction required by a browsing person with using only ID information, association of the ID with the private information is stored in a node on the browsing person's side, and the private information is synthesized and displayed when a transaction result is received (Patent Document 1).

### PRIOR ART DOCUMENT

### Patent Document

Patent Document 1: Japanese Patent Application Laid-Open Publication No. 2002-99511

### DISCLOSURE OF THE INVENTION

### Problems To Be Solved By the Invention

In order to understandably feeding back the organization dynamics to the customer, it is required to display an activity state of an operating member in the organization or an activity state of the organization or a team with using an individual name. This means that it is required to receive the private information of the customer by the service provider, and it is required to carefully treat the private information for privacy protection.

Also, since the information of workers working in the organization is treated, consideration by which the service is not taken as monitoring them is required. In order to achieve this consideration, it is required to provide such a service that the organization dynamics information is published to not only a manager of the organization but also the members of the entire organization and merits are given to the members themselves as well.

In the method disclosed in Patent Document 1, information of the association of the ID-private information is stored in the node of each browsing person, and a service required by each browsing person is provided based on the information about the association. Therefore, when a lot of browsing persons are handled such when the organization dynamics information is published to not only the manager of the organization but also the members, when information of a specific team or organization is published to a specific member, or others, loads such as setting or setting change related to the ID-private information are large in the method. Therefore, it is not suitable to directly use the method for the service utilizing the business microscope system.

Accordingly, in organization dynamics analysis service using a sensor, a preferred aim of the present invention is to understandably provide the organization dynamics information to a lot of members on a customer side without receiving private information such as an individual name from the customer and to simply provide these services.

Also, in order to further enhancing a value of the organization dynamics information, a system is required, in which an index related to productivity of white-collar job is defined and the index data can be dynamically provided. Accordingly, another preferred aim of the present invention is to define an effective index matched with characteristics of the white-collar job in order to enhance the value of the organization dynamics information.

### Means For Solving the Problems

The typical ones of the inventions disclosed in the present application will be briefly described as follows.

A node sends a sensor data and node identification information to a service gateway. A server calculates an organization analysis data of an organization to which a user at each node belongs, based on the sensor data, and sends the data to the service gateway. The service gateway connected with the server via the Internet converts the node identification information extracted from the organization analysis data into private information of the user, and outputs the organization analysis data containing the private information to a connected display device.

Also, the node sends a face-to-face data and an acceleration data with other node to the server. The server measures job quality of the user wearing the node based on the face-to-face data and the acceleration data.

### Effects of the Invention

A service provider does not receive private information such as a name from a customer, and organization (dynamics) analysis containing the private information can be browsed on only the customer side, and therefore, the organization analysis service can be easily provided.

Also, an effective index for a white-collar job can be fed back to the customer as a result of the organization analysis.

### BRIEF DESCRIPTIONS OF THE DRAWINGS

FIG. 1A illustrates one example of an entire configuration of a business microscope system and its components according to a first embodiment;

FIG. 1B illustrates another example of the entire configuration of the business microscope system and its components according to the first embodiment;

FIG. 1C illustrates still another example of the entire configuration of the business microscope system and its components according to the first embodiment;

FIG. 2 illustrates a configuration example of a data table according to the first embodiment;

FIG. 3 illustrates one example of a business microscope service according to the first embodiment;

FIG. 4 illustrates an expression example of organization dynamics and one example of structure information for achieving the expression according to the first embodiment;

FIG. 5 illustrates one example of a method of assigning a nameplate-type sensor node (TR) to a member of the organization, and an ID-NAME conversion table, according to the first embodiment;

FIG. 6A illustrates one example of a process of converting an organization network diagram with using the node ID information into an organization network diagram with using an individual name, according to the first embodiment;

FIG. 6B illustrates another example of the process of converting the organization network diagram with using the node ID information into the organization network diagram with using the individual name, according to the first embodiment;

FIG. 6C illustrates still another example of the process of converting the organization network diagram with using the node ID information into the organization network diagram with using an individual name, according to the first embodiment;

FIG. 6D illustrates still another example of the process of converting the organization network diagram with using the node ID information into the organization network diagram with using an individual name, according to the first embodiment;

FIG. 7A illustrates one example of a job-quality index in accordance with characteristics of a white-collar job according to a second embodiment;

FIG. 7B illustrates one example of an explanatory diagram of a job-quality determination flow in accordance with the characteristics of the white-collar job according to the second embodiment;

FIG. 8 illustrates one expression example of a decision result of the job-quality index according to the second embodiment;

FIG. 9A illustrates another expression example of the decision result of the job-quality index according to the second embodiment;

FIG. 9B illustrates still another expression example of the decision result of the job-quality index according to the second embodiment;

FIG. 10 illustrates still another expression example of the decision result of the job-quality index according to the second embodiment;

FIG. 11 illustrates still another expression example of the decision result of the job-quality index according to the second embodiment;

FIG. 12A illustrates a generation example of a productivity index generated by combination of a sensor data and a performance data according to a third embodiment;

FIG. 12B illustrates an expression example of the productivity index generated by the combination of the sensor data and the performance data according to the third embodiment;

FIG. 13A illustrates an expression example of the decision result of the job-quality index according to the second embodiment; and

FIG. 13B illustrates another expression example of the decision result of the job-quality index according to the second embodiment.

### BEST MODE FOR CARRYING OUT THE INVENTION

### First Embodiment

A first embodiment of the present invention will be described with reference to the accompanying drawings.

In order to clarify positioning and a function of a system for human behavior analysis and anatomy according to the present invention, a business microscope system is described first. Here, the business microscope system is a system for helping organization improvement by acquiring a data related to member movement or interaction among the members from sensor nodes worn on the members in the organization and clarifying organization dynamics as an analysis result of the data.

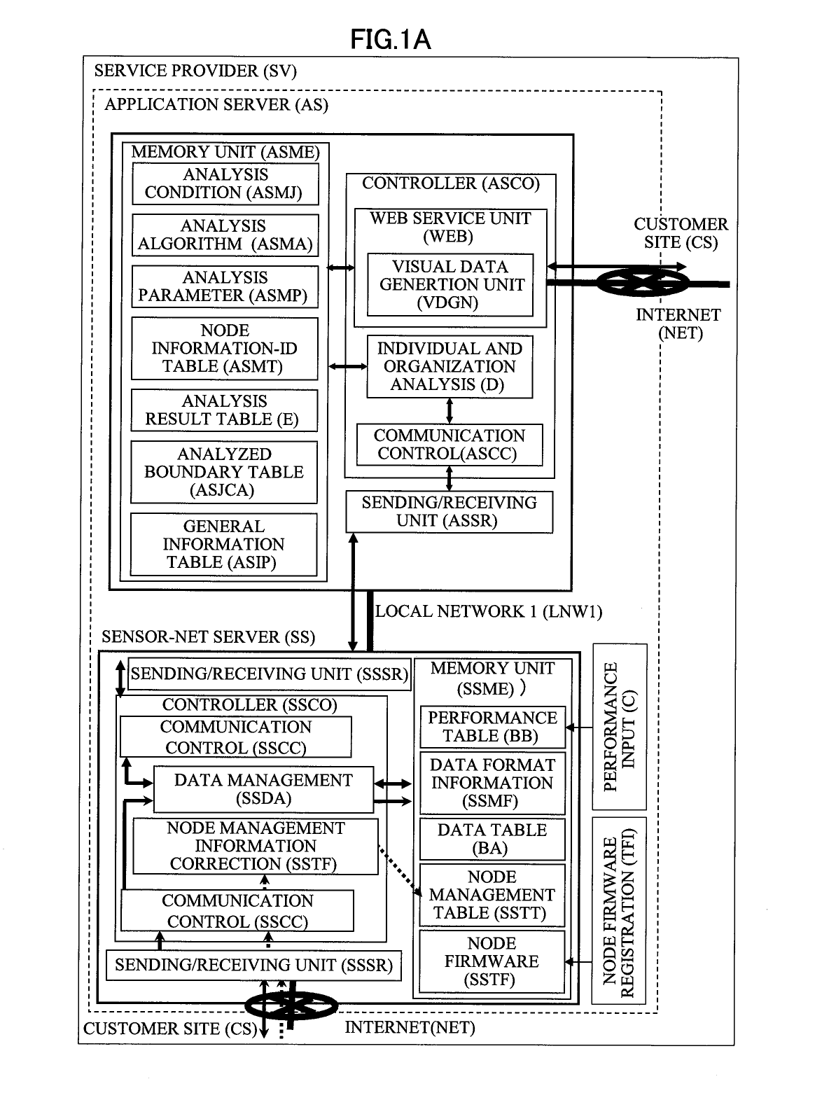

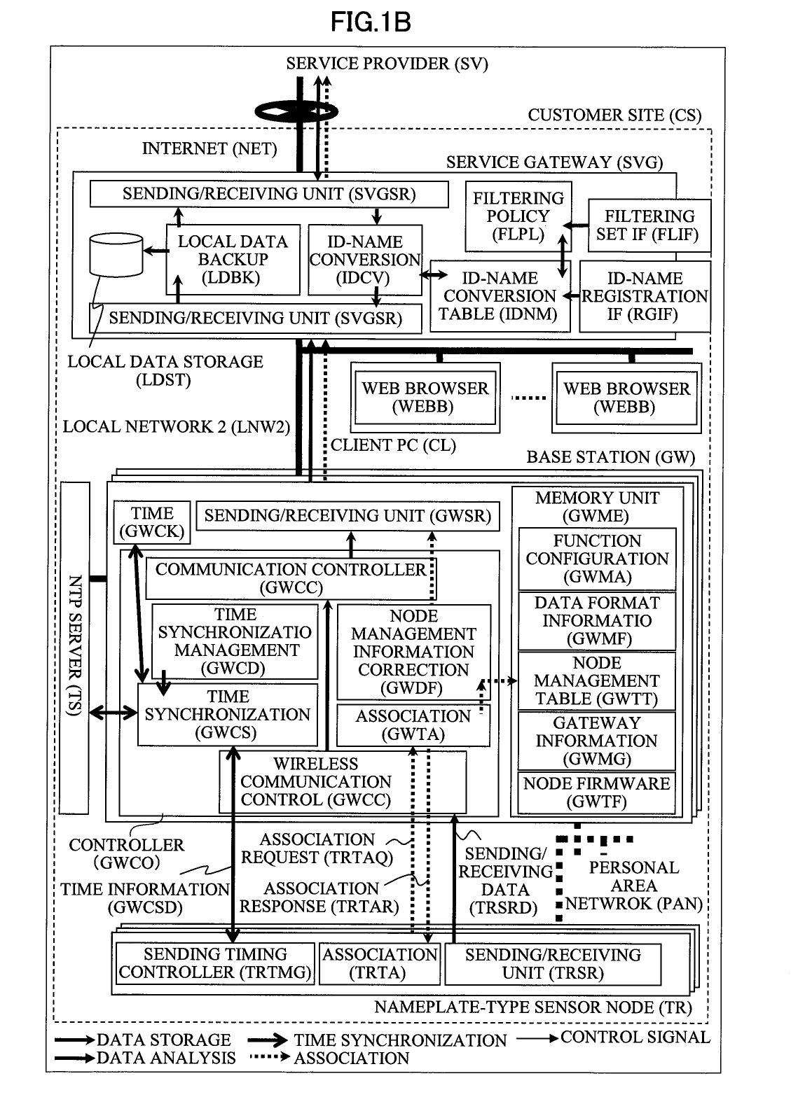

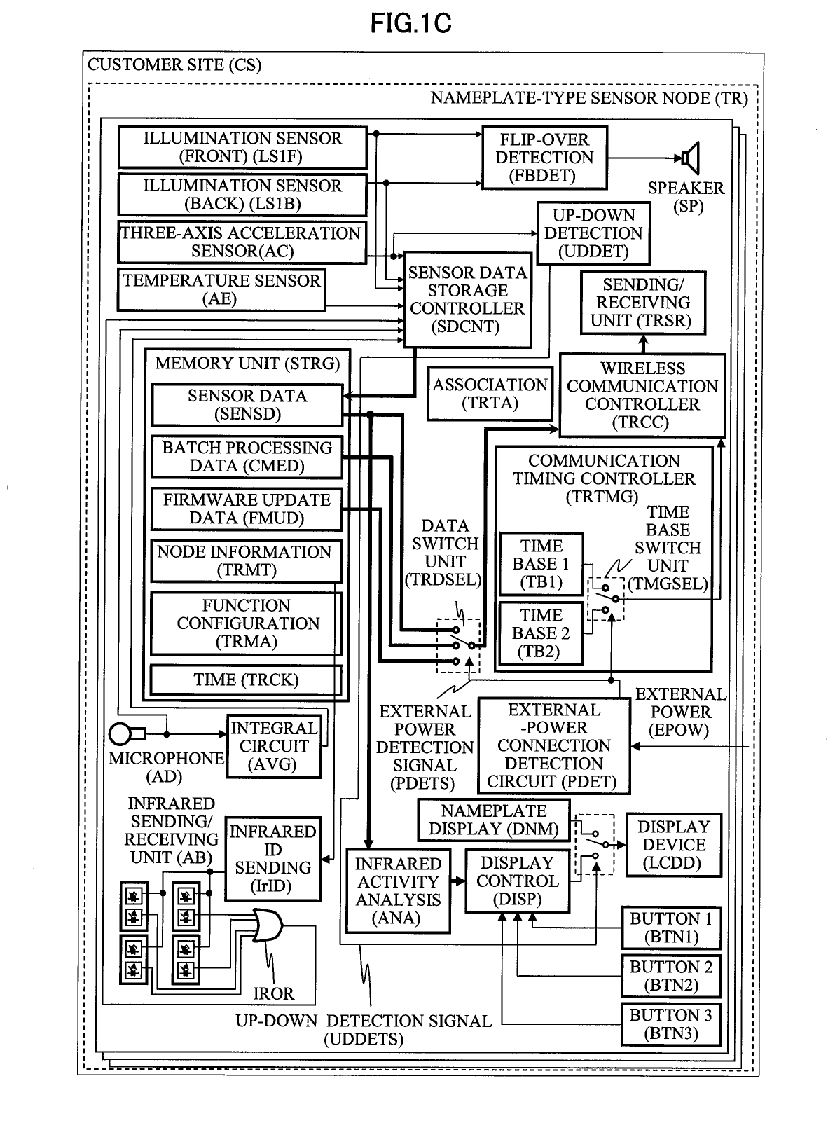

FIGS. 1A, 1B, and 1C are explanatory diagrams illustrating an entire configuration of the business microscope system and its components.

The system includes: a nameplate-type sensor node (TR); abase station (GW); a service gateway (SVG); a sensor-net server (SS); and an application server (AS). Although these components are dividedly illustrated in three diagrams of FIGS. 1A, 1B, and 1C for convenience of illustrations, each illustrated process is mutually executed in cooperation with the other. FIG. 1A illustrates the sensor-net server (SS) and the application server (AS), which are installed on a service provider (SV) of the business microscope system. The sensor-net server (SS) and the application server (AS) are connected with each other by a local network 1 (LNW1) inside the service provider (SV). Also, FIG. 1B illustrates the nameplate-type sensor node (TR), the base station (GW), and the service gateway (SVG), which are used on a customer site (CS) of the business microscope. The nameplate-type sensor node (TR) and the base station (GW) are connected with each other with the wireless communication, and the base station (GW) and the service gateway (SVG) are connected with each other by a local network 2 (LNW2). Further, FIG. 1C illustrates a detailed configuration of the nameplate-type sensor node (TR).

First, a series of flow is described up to a process that a sensor data acquired from the nameplate-type sensor node (TR) illustrated in FIGS. 1B and 1C reaches the sensor-net server (SS) storing the sensor data via the base station (GW) and the service gateway (SVG), and a process for the data by the application server (AS) analyzing the organization dynamics.

The nameplate-type sensor node (TR) illustrated in FIGS. 1B and 1C is described. The nameplate-type sensor node (TR) mounts each type of sensors such as a plurality of infrared sending/receiving unit (AB) for detecting a face-to-face state among persons, a three-axis acceleration sensor (AC) for detecting movement of the wearing member, a microphone (AD) for detecting conversation of the wearing member and surrounding noise, illumination sensors (LS1F and LS1B) for detecting front and back (flipping-over) of the nameplate-type sensor node, and a temperature sensor (AE). The mounted sensors are described as one example, and other sensors may be used for detecting the face-to-face state of the wearing member and movement thereof.

In the present embodiment, four pairs of the infrared sending/receiving units are mounted. The infrared sending/receiving unit (AB) periodically and continuously sends node information (TRMT) which is a specific identification data of the nameplate-type sensor node (TR) toward a front side direction. When a person on whom another nameplate-type sensor node (TR) is worn is positioned in the substantial front side (for example, front side or obliquely front side), the nameplate-type sensor node (TR) and another nameplate-type sensor node (TR) mutually transfers their node information (TRMT) by infrared rays. Therefore, information about who is facing whom can be recorded.

Generally, each infrared sending/receiving unit is configured with combination of an infrared emission diode for the infrared transmission and an infrared phototransistor. An infrared ID sending unit (IrID) generates the node information (TRMT) of its ID and transfers the information to the infrared emission diode in an infrared transmission/reception module. In the present embodiment, by sending the same data to a plurality of infrared transmission/reception modules, all infrared emission diodes are simultaneously lighted. Of course, each of different data may be outputted at individual timing.

Also, for data received by the infrared phototransistor of the infrared sending/receiving unit (AB), logical addition (OR operation) is calculated by an OR circuit (IROR). That is, when the ID emission is received by at least one of infrared receivers, the emission is identified as the ID by the nameplate-type sensor node. Of course, there may be provided a structure individually having a plurality of receiver circuits for the ID. In this case, receiving/sending states can be figured out for each of the infrared transmission/reception modules, and therefore, additional information such as a direction in which another facing nameplate-type sensor node is positioned can be obtained.

A sensor data (SENSD) detected by the sensor is stored in a memory unit (STRG) by a sensor data storage controller (SDCNT). The sensor data (SENSD) is converted into a transmission packet data by a wireless communication controller (TRCC), and is sent to the base station (GW) by a sending/receiving unit (TRSR).

At this time, a communication timing controller (TRTMG) retrieves the sensor data (SENSD) from the memory unit (STRG), and generates timing for the wireless transmission. The communication timing controller (TRTMG) includes a plurality of time bases (TB1 and TB2) generating a plurality of timings.

As the data stored in the memory unit, in addition to the sensor data (SENSD) detected by the sensor at the moment, there are batch-processing data (CMBD) acquired by the sensor at the past moment and stored therein and a firmware update data (FMUD) for updating a firmware which is an operation program for the nameplate-type sensor node.

The nameplate-type sensor node (TR) according to the present embodiment detects connection of an external power (EPOW) with using an external power detector circuit (PDET) and generates an external power detection signal (PDETS). Based on the external power detection signal (PDETS), a transmission timing and wirelessly-communicated data which are generated by the timing controller (TRTMG) are switched by a timing base switching unit (TMGSEL) and a data switching unit (TRDSEL), respectively.

The illumination sensors (LS1F and LS1B) are mounted on front and back sides of a nameplate-type sensor node (NN), respectively. The data acquired by the illumination sensors (LS1F and LS1B) is stored in the memory unit (STRG) by a sensor data storage controller (SDCNT), and is simultaneously compared by a flip-over detection (FBDET). When the nameplate is correctly worn, the illumination sensor (LS1F) mounted on the front side receives external light, and the illumination sensor (LS1FB) mounted on the back side does not receive the external light because it is positioned between the nameplate-type sensor node body and the wearing person. At this time, illumination intensity detected by the illumination sensor (LS1F) has a larger value than that detected by the illumination sensor (LS1B). On the other hand, when the nameplate-type sensor node (TR) is flipped over, the illumination sensor (LS1B) receives the external light and the illumination sensor (LS1F) is turned on the wearing person side, and therefore, the illumination intensity detected by the illumination sensor (LS1B) is larger than that detected by the illumination sensor (LS1F).

Here, by comparing the illumination intensity detected by the illumination sensor (LS1F) with the illumination intensity detected by the illumination sensor (LS1B) in the flip-over detection (FBDET), it can be detected that the nameplate node is flipped over and incorrectly worn. When the flipping-over is detected in the flip-over detection (FBDET), warning tone is generated from a speaker (SP) to notice the wearing person the flipping-over.

The microphone (AD) acquires voice information. By the voice information, surrounding environment such as “loud” or “quiet” can be known. Further, by acquiring and analyzing human voice, quality of face-to-face communication such as active communication or stagnant communication, mutually making equal conversation or one-side conversation, or being angry or laugh, can be analyzed. Still further, a face-to-face state which cannot be detected by the infrared sending/receiving unit (AB) due to a standing position of a person or others can be supported by the voice information and/or acceleration information.

As the voice acquired by the microphone (AD), both of speech waveform and signals obtained by integration of the speech waveform by an integration circuit (AVG) are acquired. The integrated signals represent energy of the acquired voice.

The three-axis acceleration sensor (AC) detects acceleration of the node, which is movement of the node. Therefore, from the acceleration data, behavior of the person on whom the nameplate-type sensor node (TR) is worn, such as strenuous movement or walking, can be analyzed. Further, by comparing acceleration values with each other, which are detected by the plurality of nameplate-type sensor nodes, degree of activity of the communication among persons on whom these nameplate-type sensor nodes are worn, mutual rhythm thereof, mutual relation thereof, or others, can be analyzed.

In the nameplate-type sensor node (TR) according to the present embodiment, at the same time when the data acquired by the three-axis acceleration sensor (AC) is stored in the memory unit (STRG) by the sensor data storage controller (SDCNT), the direction of the nameplate is detected by an up-down detection circuit (UDDET). In the detection, two types of measurement are used as the acceleration detected by the three-axis acceleration sensor (AC), the measurement being dynamic acceleration change caused by the movement of the wearing person and statistic acceleration caused by acceleration of gravity of the earth.

On a display device (LCDD), when the nameplate-type sensor node (TR) is worn on a chest, private information such as a team name of the wearing person or a name thereof is displayed. That is, the sensor node acts as a nameplate. On the other hand, when the wearing person holds the nameplate-type sensor node (TR) in the person's hand and turns the display device (LCDD) to him/her, up/downsides of the nameplate-type sensor node (TR) are reversed. At this time, by an up-down detection signal (UDDETS) generated by an up-down detection circuit, contents displayed on the display device (LCDD) and functions of buttons are switched. The present embodiment exemplifies that, depending on a value of the up-down detection signal (UDDETS), the information to be displayed on the display device (LCDD) is switched to the nameplate display (DNM) or an analysis result of an infrared activity analysis (ANA) generated by a display control (DISP).

By the infrared communication among the nodes by the infrared sending/receiving units (AB), it is detected whether the nameplate-type sensor node (TR) faces the other nameplate-type sensor node (TR) or not, that is whether a person on whom the nameplate-type sensor node (TR) is worn faces a person on whom the other nameplate-type sensor node (TR) is worn or not. For the detection, it is desirable that the nameplate-type sensor node (TR) is worn on a front side of the person.

In many cases, a plurality of nameplate-type sensor nodes are provided, and each of them is connected to a base station (GW) close to itself to form a personal area network (PAN).

The temperature sensor (AE) of the nameplate-type sensor node (TR) acquires temperature of a place where the nameplate-type sensor node exists, and the illumination sensor (LS1F) thereof acquires illumination intensity of the front side of the nameplate-type sensor node (TR) or others. In this manner, the surrounding environment can be recorded. For example, based on the temperature and the illumination intensity, it can be also found out that the nameplate-type sensor node (TR) moves from one place to the other place.

As an input/output device for the wearing person, buttons 1 to 3 (BTN 1 to 3), the display device (LCDD), the speaker (SP), and others are mounted.

The memory unit (STRG) is specifically configured with a nonvolatile storage device such as a hard disk or a flash memory, and records node information (TRMT) which is a specific identification number of the nameplate-type sensor node (TR), sensing interval, operation setting (TRMA) for the output content onto the display or others, and time (TRCK). Note that the sensor node is intermittently operated so as to repeat an active state and an idle state at a certain interval for power saving. In the operation, necessary hardwares are driven only when tasks such as the sensing or data transmission are executed. When there is no task to be executed, a CPU or others is set to a low-power mode. The sensing interval here means interval in which the sensing is performed in the active state. Also, in addition to them, the memory unit (STRG) can temporarily record data, and is used for recording the sensed data.

The communication timing controller (TRTMG) stores time information (GWCSD) and updates the time information (GWCSD) in each certain interval. In the time information, in order to prevent shift of the time information (GWCSD) from that of the other nameplate-type sensor node (TR), the time is periodically corrected by the time information (GWCSD) sent from the base station (GW).

The sensor data storage controller (SDCNT) controls the sensing interval of each sensor in accordance with the operation setting (TRMA) recorded in the memory unit (STRG) or others, and manages the acquired data.

In the time synchronization, the time information is acquired from the base station (GW) to correct the time. The time synchronization may be executed right after an associate operation described later, or may be executed in accordance with a time synchronization command sent from the base station (GW).

The wireless communication controller (TRCC) controls a transmission interval in the data transmission/reception, and converts the data into a data having a data format compatible with the wireless transmission/reception. The wireless communication controller (TRCC) may have a function with not wireless but wire communication if needed. The wireless communication controller (TRCC) controls congestion sometimes so as not to overlap the transmission timing with that of the other nameplate-type sensor node (TR).

An association (TRTA) sends an associate request (TRTAQ) and receives an associate response (TRTAR) to/from the base station (GW) illustrated in FIG. 1B for forming the personal area network (PAN), so that the base station (GW) to which the data is to be sent is determined. The association (TRTA) is executed when power of the nameplate-type sensor node (TR) is turned on or when the transmission/reception with the base station (GW) at the moment is cut due to the movement of the nameplate-type sensor node (TR). By a result obtained by the association (TRTA), the nameplate-type sensor node (TR) is associated with one base station (GW) which exists in a close area where the wireless signal from this nameplate-type sensor node (TR) reaches.

A sending/receiving unit (TRSR) includes an antenna, and sends/receives the wireless signal. If needed, the sending/receiving unit (TRSR) can perform the transmission/reception with using a connector for the wire communication. A data (TRSRD) sent/received by the sending/receiving unit (TRSR) is transferred to the base station (GW) via the personal area network (PAN).

Next, a function of the base station (GW) illustrated in FIG. 1B is described. The base station (GW) has a function of sending the sensor data received with using the wireless signal from the nameplate-type sensor node (TR), to the service gateway (SVG). The necessary number of base stations (GW) is installed in consideration of a distance covered by the wireless communication and an area size in which a measure-target organization exists.

The base station (GW) includes: a controller (GWCO); a memory unit (GWME); a time unit (GWCK); and a sending/receiving unit (GWSR).

The controller (GWCO) includes a CPU (whose illustration is omitted). The CPU executes a program stored in the memory (GWME) to manage the acquiring timing for the sensing data sensor information, a process for the sensing data, the transmission/reception timing to/from the nameplate-type sensor node (TR) and the sensor-net server (SS), and the timing for the time synchronization. More specifically, the CPU executes the program stored in the memory (GWME) to execute processes such as wireless communication control/controller (GWCC), the data format conversion, the association (GWTA), time synchronization management (GWCD), the time synchronization (GWCS), and others.

The wireless communication control/controller (GWCC) controls the timing for the communication with the nameplate-type sensor node (TR) and the service gateway (SVG) with the wireless or wire communication. Also, the wireless communication control/controller (GWCC) identifies a type of the receiving data. More specifically, the wireless communication control/controller (GWCC) identifies the receiving data as a normal sensing data, a data for the association, the response for the time synchronization, or others from a header of the data, and passes these data to each suitable function.

Note that the wireless communication control/controller (GWCC) references the data format information (GWMF) recorded in the memory (GWME), converts the data into a data having a format suitable for the transmission/reception, and executes the data format conversion which adds tag information for describing the type of the data.

The association (GWTA) sends the response (TRTAR) for the associate request (TRTAQ) sent from the nameplate-type sensor node (TR), so that a local ID is assigned to each nameplate-type sensor node (TR). When the associate process is completed, the association (GWTA) corrects node management information with using a node management table (GWTT) and a node firmware (GWTF).

The time synchronization management (GWCD) controls the interval and timing for the execution of the time synchronization, and outputs a command of the time synchronization. Alternatively, the sensor-net server (SS) installed on a service provider (SV) site executes the time synchronization management (GWCD), so that the command may be controlled and sent from the sensor-net server (SS) to the base station (GW) in a whole system.

The time synchronization (GWCS) is connected to an NTP server (TS) on a network, and acquires the time information. The time synchronization (GWCS) periodically updates the information of the time (GWCK) based on the acquired time information. Also, the time synchronization (GWCS) sends the command of the time synchronization and the time information (GWCD) to the nameplate-type sensor node (TR). By this system, in the plurality of nameplate-type sensor nodes (TR) connected to the base station (GW), the time synchronization can be maintained among the nodes.

The memory (GWME) is configured with a nonvolatile memory device such as a hard disk or a flash memory. In the memory (GWME), at least the operation setting (GWMA), the data format information (GWMF), the node management table (GWTT), and the base-station information (GWMG) are stored. The operation setting (GWMA) contains information describing a method of operating the base station (GW). The data format information (GWMF) contains information describing the data format for the communication and information required for adding the tag to the sensing data. The node management table (GWTT) contains the node information (TRMT) of the controlled nameplate-type sensor nodes (TR) which has been already associated at the moment, and the local ID distributed for managing these nameplate-type sensor nodes (TR). The base-station information (GWMG) contains information such as an address of the base station (GW) itself. Also, in the memory (GWME), the firmware (GWTF) mounted on the nameplate-type sensor node is temporarily stored.

Further, in the memory (GWME), the program executed by the central processor unit CPU (whose illustration is omitted) in the controller (GWCO) may be stored.

The time unit (GWCK) corrects its own time information in each certain period based on the time information acquired from the NTP (Network Time Protocol) server (TP) for maintaining the time information.

The sending/receiving unit (GWSR) receives the wireless signal from the nameplate-type sensor nodes (TR), and sends the data to the service gateway (SVG) via a local network 2 (LNW2).

Next, an upstream process in the service gateway (SVG) illustrated in FIG. 1B is described. The service gateway (SVG) sends the data collected from all base stations (GW) to the service provider (SV) via the Internet (NET). Also, for the backup of the sensor data, the data acquired from the base station (GW) is stored in a local data storage (LDST) by the control of a local data backup (LDBK). The data transmission/reception to/from the base station and the data transmission/reception to/from the Internet side are performed by a sending/receiving unit (SVGSR). A downstream process in the service gateway (SVG) and a function of a client PC (CL) connected to the local network (LNW2) will be described later.

Next, the sensor-net server (SS) illustrated in FIG. 1A is described. The sensor-net server (SS) installed on the service provider (SV) site manages the data collected by all nameplate-type sensor nodes (TR) operated on a customer site (CS). More specifically, the sensor-net server (SS) stores the data sent via the Internet (NET) in a database, and sends the sensor data based on requests from an application server (AS) and the client PC (CL). Further, the sensor-net server (SS) receives a control command from the base station (GW), and responses a result obtained by the control command to the base station (GW).

The sensor-net server (SS) includes: a sending/receiving unit (SSSR); a memory unit (SSME); and a controller (SSCO). When the time synchronization management (GWCD) is executed in the sensor-net server (SS), the sensor-net server (SS) requires the time as well.

The sending/receiving unit (SSSR) performs data transmission/reception among the base station (GW), the application server (AS), and the service gateway (SVG). More specifically, the sending/receiving unit (SSSR) receives the sensing data sent from the service gateway (SVG), and sends the sensing data to the application server (AS).

The memory unit (SSME) is configured with a nonvolatile memory device such as a hard disk or a flash memory, and stores at least a performance table (BB), a data format information (SSMF), a data table (BA), and a node management table (SSTT). Further, the memory unit (SSME) may store a program executed by a CPU (whose illustration is omitted) in the controller (SSCO). Still further, in the memory unit (SSME), an updated firmware (SSTF) of the nameplate-type sensor node stored in a node firmware register (TFI) is temporarily stored.

The performance table (BB) is a database for recording assessment (performance) of the organization or person inputted from the nameplate-type sensor node (TR) or an existing data, together with the time data.

The data format information (SSMF), a data format for the communication, a method of separating the sensing data tagged in the base station (GW) and recording the data in the database, a method of responding the data request, and others are recorded. As described later, the data format information (SSMF) is always referred by the communication controller (SSCC) before/after the data transmission/reception, and data format conversion (SSMF) and data management (SSDA) are performed.

The data table (BA) is a database for recording the sensing data acquired by each nameplate-type sensor node (TR), the information of the nameplate-type sensor node (TR), the information of the base station (GW) through which the sensing data sent from each nameplate-type sensor node (TR) passes, and others. A column is formed in each data element such as the acceleration and temperature, so that the data is managed. Alternatively, the table may be formed in each data element. In either case, for all data, the node information (TRMT) which is the acquired ID of the nameplate-type sensor node (TR) is managed to be associated with the information related to the acquired time.

The node management table (SSTT) is a table for recording information about which nameplate-type sensor node (TR) is controlled by which base station (GW) at the moment. When a new nameplate-type sensor node (TR) is added under the control of the base station (GW), the node management table (SSTT) is updated.

The controller (SSCO) includes a central processor unit CPU (whose illustration is omitted), and controls the transmission/reception of the sensing data and the recording/retrieving thereof to/from the database. More specifically, the CPU executes the program stored in the memory unit (SSME), so that processes such as communication control (SSCC), node management information correction (SSTF), and data management (SSDA) are executed.

The communication controller (SSCC) controls timings of the communications with the service gateway (SVG), the application server (AS), and the customer (CL). Also, as described above, the communication controller (SSCC) converts the format of the sent/received data into a data format in the sensor-net server (SS) or a data format specialized for each communication target based on the data format information (SSMF) recorded in the memory unit (SSME). Further, the communication controller (SSCC) reads the header part describing the type of the data, and distributes the data to a corresponding process unit. More specifically, the received data is distributed to the data management (SSDA), and the command for correcting the node management information is distributed to the node management information correction (SSTF). An address to which the data is sent is determined by the base station (GW), the service gateway (SVG), the application server (AS), or the customer (CL).

The node management information correction (SSTF) updates the node management table (SSTT) when it receives the command for correcting the node management information.

The data management (SSDA) manages the correction of the data in the memory unit (SSME), the acquirement thereof, and the addition thereof. For example, by the data management (SSDA), the sensing data is recorded in an appropriate column in the database in each data element based on the tag information. Even when the sensing data is retrieved from the database, processes are performed, in which the necessary data is selected based on the time information and the node information and is sorted by the time.

The data received by the sensor-net server (SS) via the service gateway (SVG) is organized and recorded in the performance table (BB) and the data table (BA) by the data management (SSDA).

Last, the application server (AS) illustrated in FIG. 1A is described. The application server (AS) receives a request from the client PC (CL) on the customer site (CS) or sends a request to the sensor-net server (SS) for the automatic analysis process for the sensing data at a set time, acquires the necessary sensing data, analyzes the acquired data, and sends the analyzed data to the client PC (CL). The original analyzed data may be recorded in the analysis database. The application server (AS) includes: a sending/receiving unit (ASSR); a memory unit (ASME); and a controller (ASCO).

The sending/receiving unit (ASSR) sends/receives the data to/from the sensor-net server (SS) and the service gateway (SVG). More specifically, the sending/receiving unit (ASSR) receives a command sent via the client PC (CL) and the service gateway (SVG), and sends a data acquisition request to the sensor-net server (SS). Further, the sending/receiving unit (ASSR) sends an analyzed data to the client PC (CL) via the service gateway (SVG).

The memory unit (ASME) is configured with an external record device such as a hard disk, memory, or SD card. The memory unit (ASME) stores a setting condition for the analysis and its analyzed data. More specifically, the memory unit (ASME) stores an analysis condition (ASMJ), an analysis algorithm (ASMA), an analysis parameter (ASMP), an node information-ID table (ASMT), an analysis result table (E), an analyzed boundary table (ASJCA), and a general information table (ASIP).

The analysis condition (ASMJ) temporarily stores an analysis condition for a display method requested from the client PC (CL).

The analysis algorithm (ASMA) records a program for the analysis. In accordance with the request from the client PC (CL), an appropriate program is selected, and the analysis is executed by the program.

The analysis parameter (ASMP) records, for example, a parameter for extracting an amount of characteristic or others. When the parameter is changed by a request of the client PC (CL), the analysis parameter (ASMP) is rewritten.

The node information-ID table (ASMT) is a correspondence table of the ID of the node with another ID associated with the node, attribute information, and others.

The analysis result table (E) is a database for storing a data analyzed by an individual and organization analysis (D).

In the analyzed boundary table (ASJCA), an area analyzed by the individual and organization analysis (D) and time at which the analysis is processed are shown.

The general information table (ASIP) is a table used as an index when the individual and organization analysis (D) is executed.

The controller (ASCO) includes a central processor unit CPU (whose illustration is omitted), and executes to control the data transmission/reception and analyze the sensor data. More specifically, the CPU (whose illustration is omitted) executes a program stored in the memory unit (ASME), so that the communication control (ASCC), the individual and organization analysis (D), and a Web service (WEB) are executed.

The communication control (ASCC) controls timing for the communication with the sensor-net server (SS) with using the wire or wireless communication. Further, the communication control (ASCC) executes the data format conversion and the distribution of the address for each type of the data.

The individual and organization analysis (D) executes the analysis process written in the analysis algorithm (ASMA) with using the sensor data, and stores the analyzed result in the analysis result table (E). Further, the analyzed boundary table (ASJCA) describing the analyzed area is updated.

The Web service (WEB) has a server function that, when the Web service receives a request from the client PC (CL) on the customer site (CS), the analyzed result stored in the analysis result table (E) is converted into a data required for the expression in a visual data generator (VDGN), and then, the data is sent to the client PC (CL) via the Internet (NET). More specifically, information such as the display content or drawing position information is sent as having a format such as HTML (Hyper Text Makeup Language).

Note that, in the present embodiment, the execution of the storage and management for the collected sensor data, the analysis for the organization dynamics, and others by the functions each included in the sensor-net server and the application server is described. However, it is needless to say that they can be executed by one server having both functions.

In the foregoing, the sequential flow is described up to the reach of the sensor data acquired from the nameplate-type sensor node (TR) to the application server (AS) for the organization analysis.

Next, a process that the client PC (CL) on the customer site (CS) requests a result of the organization analysis to the service provider is described.

The result of the organization analysis requested by the client PC (CL) reaches the service gateway (SVG) via the Internet (NET). Here, the downstream process in the service gateway (SVG) is described. The downstream process in the service gateway (SVG) is executed by an ID-NAME conversion (IDCV), an ID-NAME conversion table (IDNM), a filtering policy (FLPL), a filtering set IF (FLIF), and an ID-NAME registration IF (RGIF).

When the data of the organization analysis inputted via the sending/receiving unit (SVGSR) reaches the ID-NAME conversion (IDCV), the ID contained in the result of the organization analysis is converted into an individual name registered in the ID-NAME conversion table (IDNM).

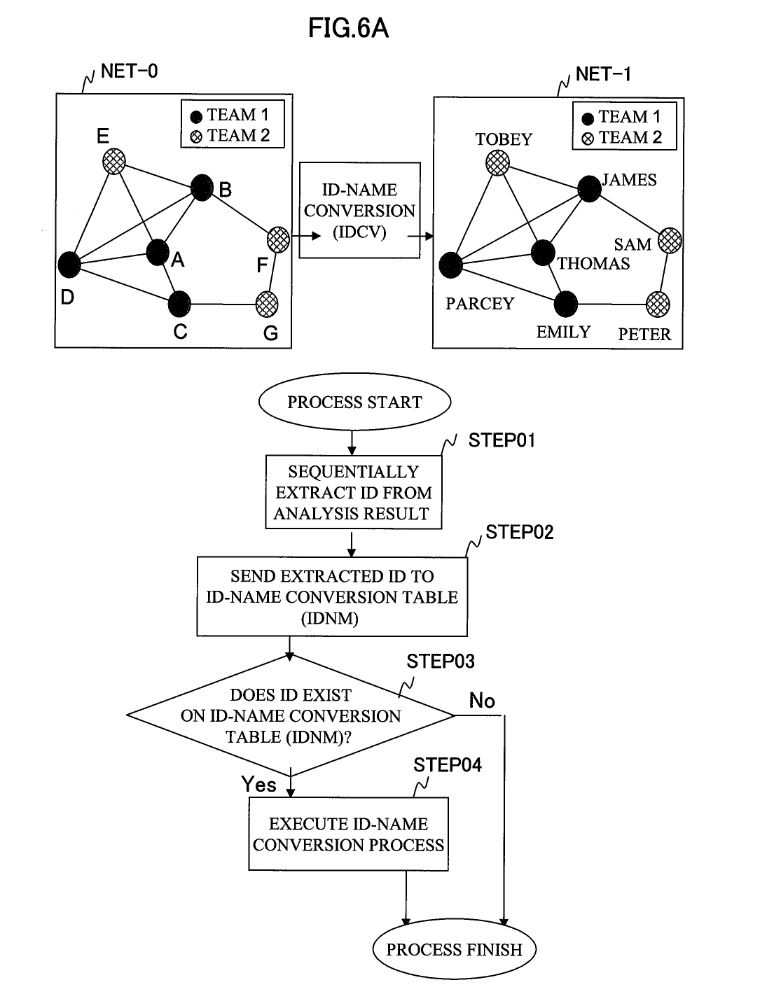

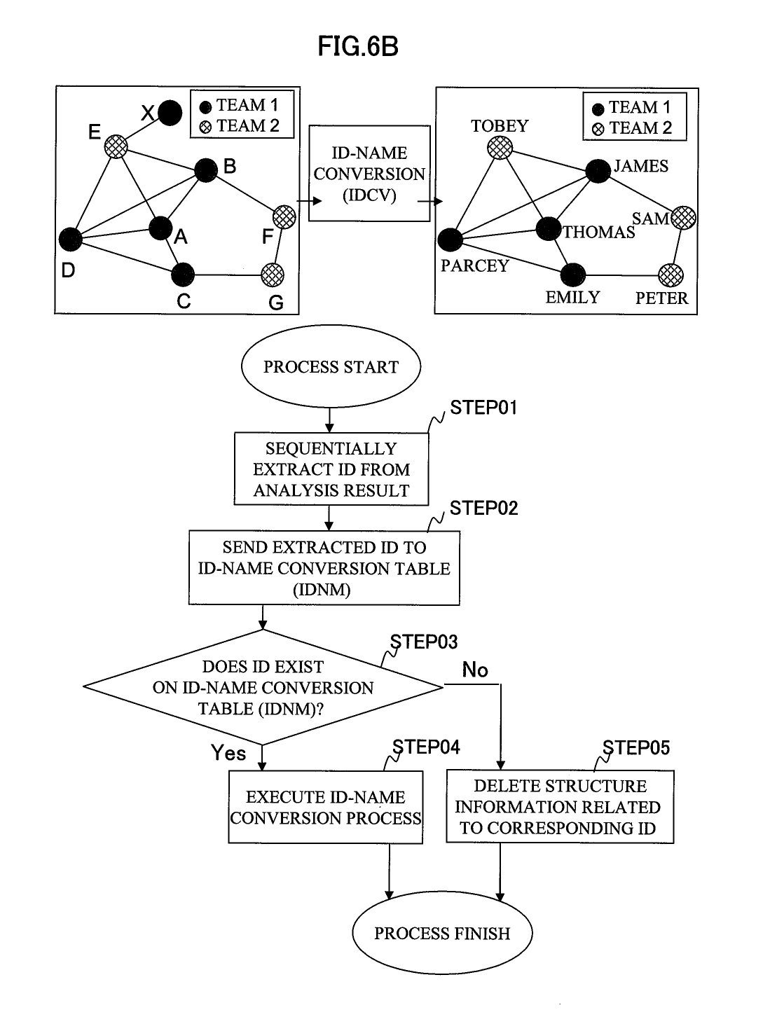

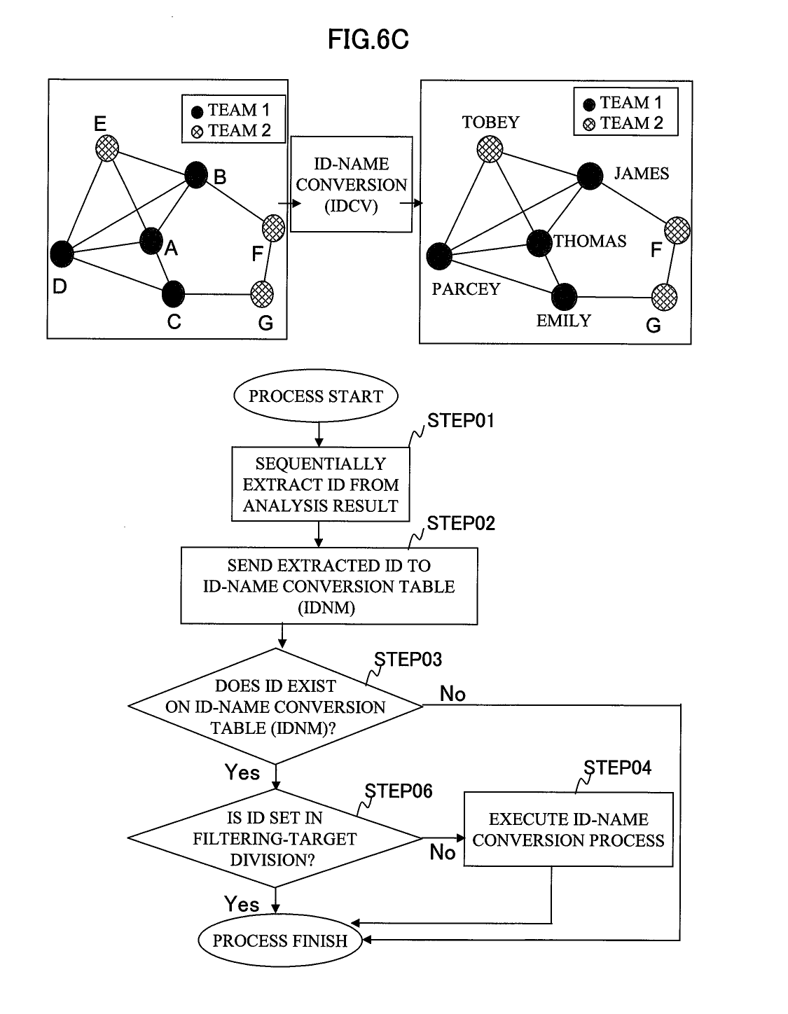

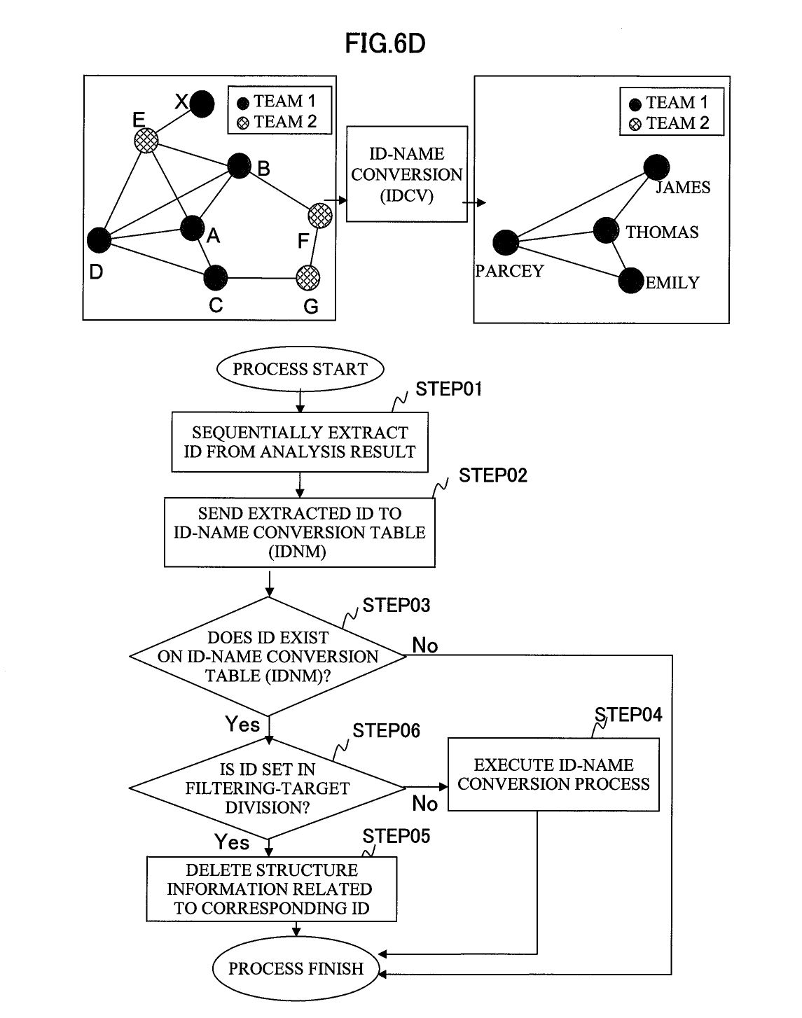

Also, when it is desirable to partially perform the ID-NAME conversion (IDCV) for the result of the organization analysis, its policy is previously registered in the filtering policy (FLPL). Here, the policy is a condition for determining the expression method of the result of the organization analysis on the client PC. More specifically, the condition is the one for determining whether the ID contained in the result of the organization analysis is converted into the name or not, the one for determining whether structure information related to unknown ID not existing in the organization is deleted or not, or others. An example in which the result of the organization analysis is expressed based on the policy recorded in the filtering policy will be described later with reference to FIGS. 6B to 6D. Note that the filtering policy (FLPL) and the ID-NAME conversion table (IDNM) are set and registered by a manager in the filtering set IF (FLIF) and the ID-NAME registration IF (RGIF), respectively.

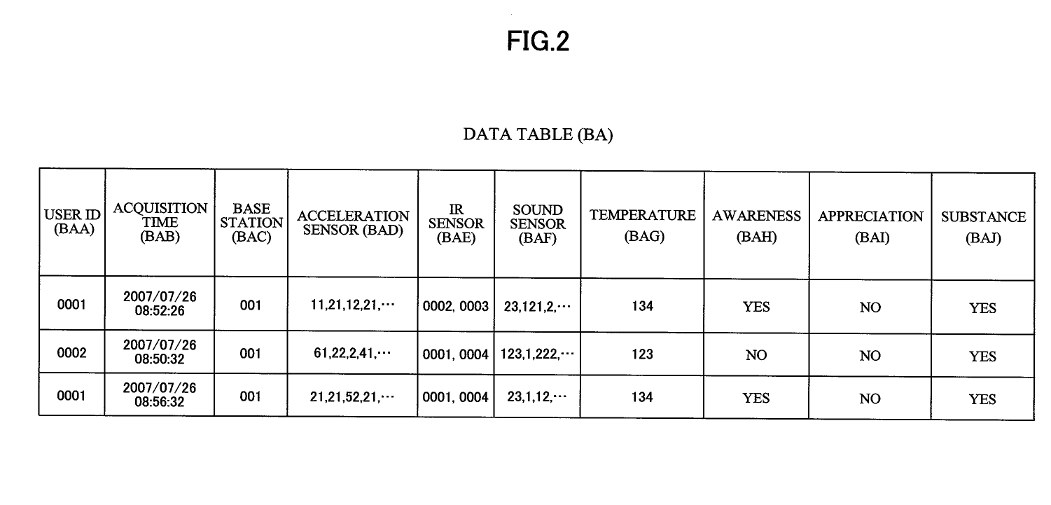

The result of the organization analysis which is converted so that the individual name can be expressed by the ID-NAME conversion (IDCV) is displayed via a Web browser (WEBB) of the client PC (CL) as having an easily-understandable format for a user. Next, a content example of the data table (BA) storing the sensor data and a performance input (C) is described with reference to FIG. 2. FIG. 2 shows a feature that the sensor data and the performance are corresponded to the time at which the sensor data is acquired and the node identification information of the sensor node. According to this feature, organization dynamics information such as a relationship among members forming the organization, for example, a connect relationship or communication centrality can be obtained. Further, combination of the sensor data and the performance can be analyzed.

A user ID (BAA) in the data table (BA) is an identifier for a user, and more specifically, a node identification information (TRMT) of a node (TR) worn on the user is stored therein.

An acquisition time (BAB) is time at which the nameplate-type sensor node (TR) acquires the sensor data, a base station (BAC) is a base station receiving the data from the nameplate-type sensor node (TR), an acceleration sensor (BAD) is a sensor data of the acceleration sensor (AC), an IR (infrared) sensor (BAE) is a sensor data of the infrared sending/receiving unit (AB), a sound sensor (BAF) is a sensor data of the microphone (AD), and a temperature (BAG) is a sensor data of the temperature (AE).

Awareness (BAH), appreciation (BAI), substance (BAJ) are data obtained by the performance input (C) or pressing/non-pressing of the buttons (BTNs 1 to 3) of the nameplate-type sensor node (TR).

Here, the performance input (C) is a process of inputting a value indicating the performance. The performance is a subjective or objective assessment determined based on any standard. For example, at a predetermined timing, a person on whom the nameplate-type sensor node (TR) is worn inputs a value of a subjective assessment (performance) based on any standard such as a degree of achievement for a job, and a degree of contribution or a degree of satisfaction for the organization at the moment. The predetermined timing may be, for example, once several hours, once a day, or a moment at which an event such as a meeting is finished. The person on whom the nameplate-type sensor node (TR) is worn can operate the nameplate-type sensor node (TR) or operate an individual computer such as the client PC (CL), and input the value of the performance. Alternatively, values noted in handwriting may be collectively inputted later by a PC. The inputted performance value is used for the analysis process. A performance related to the organization may be calculated from an individual performance. A previously-quantified data such as a questionnaire result of a customer or an objective data such as sales amount or a cost may be inputted as the performance from another system. If a numerical value such as an error incidence in manufacturing management or others can be automatically obtained, the obtained numerical value may be automatically inputted as the performance value.

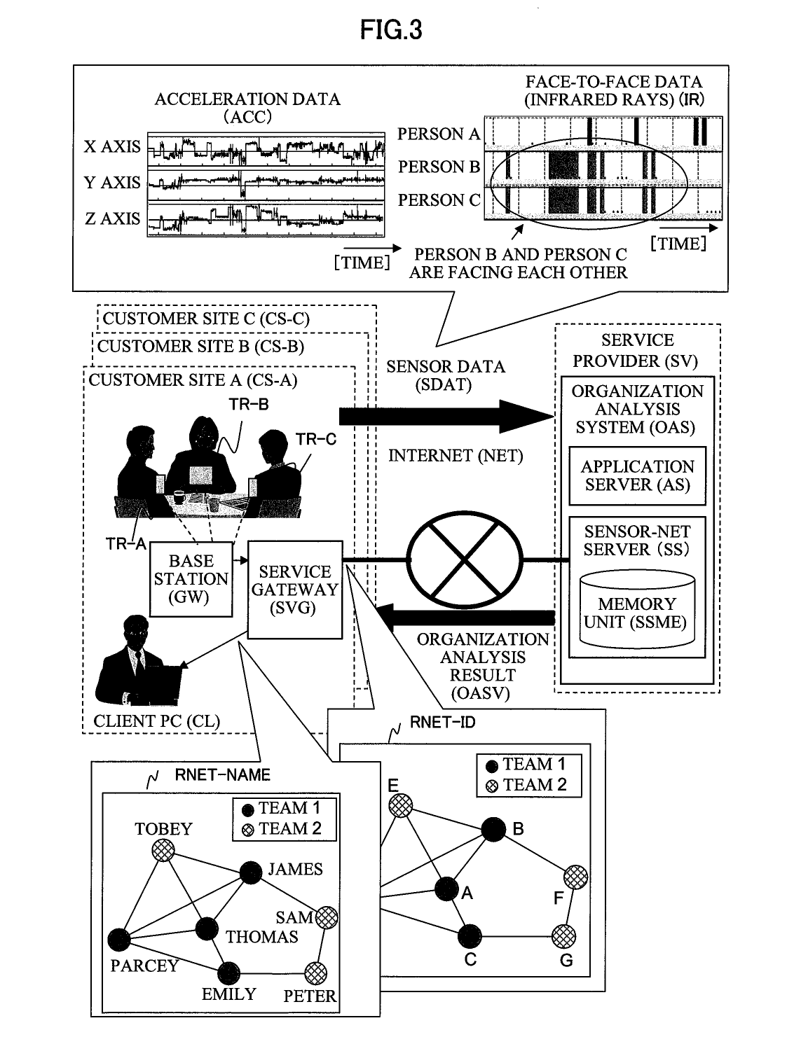

FIG. 3 illustrates an overall view of the business microscope service achieved by the function configurations illustrated in FIGS. 1A, 1B, 1C, and 2 as described above. FIG. 3 shows a feature that the sensor data associated with the ID of the sensor node is received from the customer site, the organization analysis is performed on the service provider side, and then, the organization analysis data based on the ID is fed back to the customer site. In the organization analysis data, when the customer browses the data, the ID is converted into the private information (name) in the service gateway installed on the customer site, so that the data is shown to the customer as the understandable information.

In the business microscope service illustrated in FIG. 3, sensor data (SDAT) sent from a plurality of customer sites (CS-A, CS-B, and CS-C) is received by the service provider (SV) via the Internet (NET), and is analyzed in an organization analysis system (OAS).

The sensor data (SDTA) is mainly an acceleration data (ACC), a face-to-face data (IR) obtained by infrared rays, and others. Each of them is a part of contents stored in the data table (BA) illustrated in FIG. 2. In the organization analysis system (OAS), dynamics of a target organization is analyzed in the above-described sensor-net server (SS) and/or the application server (AS), and a dynamics index of the organization obtained as a result or others is fed back to a corresponding customer site (CS) as an organization analysis result (OASV). When the organization analysis result (OASV) reaches the customer site (CS) via the Internet (NET), in the service gateway (SVG), an organization analysis result (RNET-ID) expressed with the ID is converted into an analysis result (RNET-NAME) expressed with the individual name in the organization.

Next, a method of expressing the data for providing the organization analysis service is described. In order to solve the problem of the private information which is one of problems of the present invention, it is required that the private information is not treated in the service provider (SV) and only the ID information is treated therein, and then, the ID information is converted into the individual name on the customer site (CS).

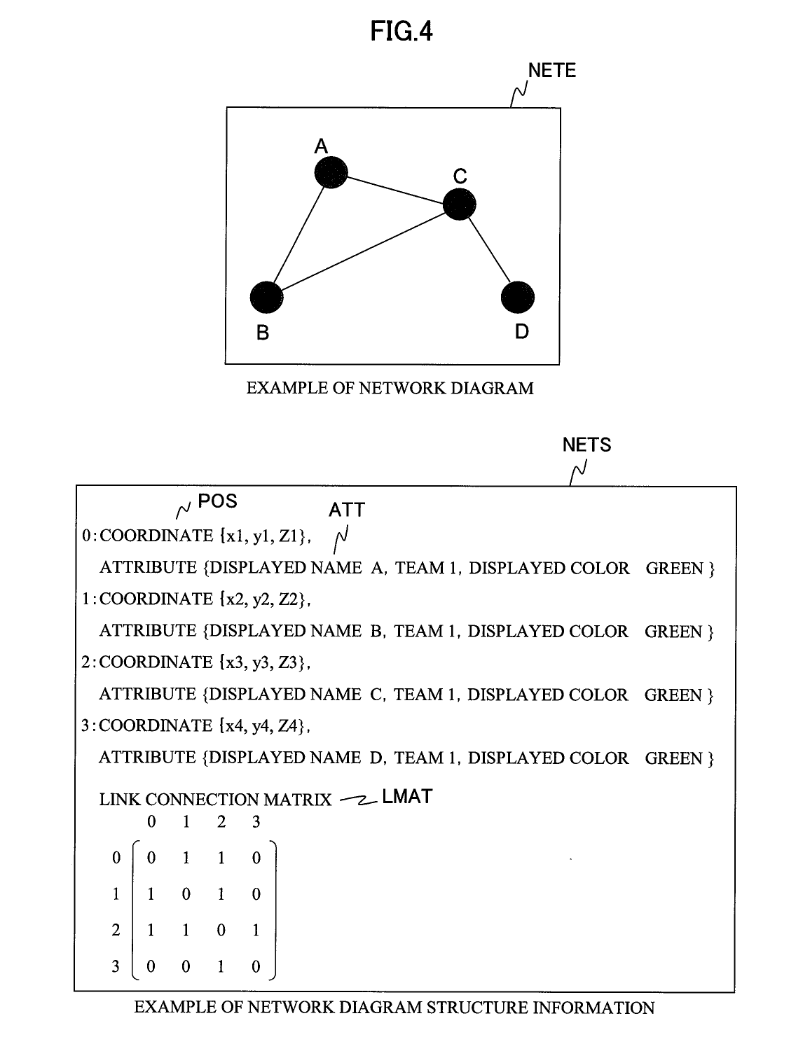

Here, as an example of specific structure information for expressing the organization dynamics, for example, expression of a network diagram (NETE) as illustrated on an upper diagram in FIG. 4 is considered. In this figure, an analysis result of a relationship among 4 members (A, B, C, and D) in the organization is illustrated. An example of the structure information (NETS) required for displaying the analysis result is illustrated on a lower diagram in FIG. 4. More specifically, the structure information is configured with: coordinate information (POS) of 4 nodes (0 to 3); attribution information (ATT) of the coordinate; and a link connection matrix (LMAT) indicating a connecting relationship among the 4 nodes. Here, the attribution (ATT) is configured with: a displayed name; a team name; and a displayed color for the node.

For the coordinate information (POS), an algorithm of fixedly determining a coordinate position depending on the number of nodes or an algorithm of displaying the coordinate position with a large number of connected nodes at a center and the coordinate position with a small number of connected nodes in a periphery of the center is used.

The link connection matrix (LMAT) is formed by counting the data of the IR sensor (BAE) in the data table (BA). More specifically, during a certain period, information about which user IDs have faced each other is counted for all combinations of target user IDs. As a result, on the matrix showing the combinations of the user IDs, “1” is written in a case with a face-to-face record, and “0” is written in a case without the face-to-face record. The numerical symbols “1” and “0” indicate the connecting relationships between the nodes in the expression with the network diagram (the numerical symbols “1” and “0” indicate that the connecting relationship between the nodes is formed or is not formed, respectively). In the present embodiment, difference between directions of the node connections (for example, a direction from a node 0 to a node 1 and a direction from the node 1 to the node 0) is not considered. However, on the link connection matrix, an expression method in consideration of the directionality can be also used.

As described above, the structure information (NETS) of the network diagram without the user name is formed in the sensor-net server (SS) and the application server (AS), and the structure information is converted into the user name in the service gateway on the customer site, so that the private information can be protected.

Further, character strings are easily extracted by forming the structure information (NETS) of the network diagram as being the structure information in which the character strings are written, and therefore, a display name of the attribution (ATT) can be extracted in the service gateway (SVG) on the customer site and the ID information can be converted into the individual name. For the conversion of the ID information into the individual name, an existing string conversion algorithm may be used. An example of a specific conversion will be described later. Note that the network diagram is exemplified here as the example of the structure information for expressing the organization dynamics. However, the network diagram is not always necessary, and the conversion into the individual name is possible even in an expression method such as a simple time chart as long as the method has a configuration capable of extracting the display name.

Also, while the character strings can be easily searched and replaced in the structure information of the network diagram in the present embodiment, the network diagram can also have image information. In this case, the character strings are extracted by applying a character recognition algorithm to the image information, the above-described string conversion algorithm is applied to the extracted character strings, and the data is converted into the image information again.

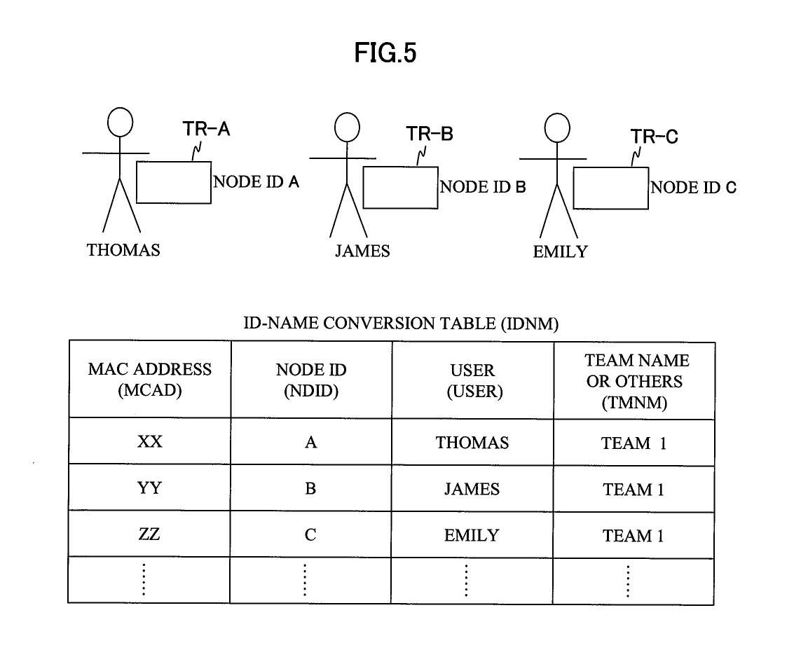

Next, a method of assigning the nameplate-type sensor node (TR) to the member in the organization is described with reference to FIG. 5. In FIG. 5, a case that each nameplate-type sensor node is assigned to three members (whose individual names are Thomas, James, and Emily) in the organization is considered. A manager (hereinafter, called a service manager) on the customer site (CS) who is related to management of the business microscope service assigns a nameplate-type sensor node TR-A to Thomas, a nameplate-type sensor node TR-B to James, and a nameplate-type sensor node TR-C to Emily. Here, a symbol “A” is assigned to a node ID of the nameplate-type sensor node TR-A, a symbol “B” is assigned to a node ID of the nameplate-type sensor node TR-B, and a symbol “C” is assigned to a node ID of the nameplate-type sensor node TR-C, respectively. As the assignation of the node IDs, there are cases that information (more specifically, the node information (TRMT)) previously set in a physical nameplate-type sensor node (TR) on the service provider (SV) side is used and that information determined on the customer site (CS) is set to the nameplate-type sensor node (TR). In the case that the node ID is determined on the customer site (CS), an ID such as a worker number in the organization for the customer, which is unique in the organization, can be assigned. The service manager forms the ID-NAME conversion table (IDNM) based on the information. The ID-NAME conversion table (IDNM) manages a corresponding relationship among information such as a MAC address (MCAD) being an identifier by which all physical nameplate-type sensor nodes (TR) can be identified, a node ID (NDID) being an identifier of a logic nameplate-type sensor node (TR), a user (USER) using the nameplate-type sensor node, and a team name (TMNM) of the user. Here, for the MAC address (MCAD), the same or partial content as the node information (TRMT) is used.

Hereinafter, with reference to FIGS. 6A to 6D, the example of the conversion of the node ID information of the organization analysis service result into the individual name in the service gateway (SVG) on the customer site (CS) is described with a specific procedure. The conversion process is performed in the ID-NAME converter (IDCV) in the service gateway (SVG). Note that the example of the conversion of the ID information into the individual name is described in the present embodiment. However, it is needless to say that the ID information can be converted into such private information as individual e-mail address or image.

First, with reference to FIG. 6A, a process of converting an organization network diagram (NET-0) using the node ID information into an organization network diagram (NET-1) using the individual name is described. The organization network diagrams (NET-0 and NET-1) used here show a communication state during a certain period, illustrated with using the face-to-face information (the data of the IR sensor (BAE) in the data table (BA)) among the members.

In FIG. 6A, node ID information (A, B, C, D, E, F, and G) of seven members in two teams (team 1 and team 2) are converted into individual names (Thomas, James, Emily, Parcy, Tobey, Sam, and Peter), respectively. The process is performed in the service gateway (SVG) in accordance with a process flow of FIG. 6A.

First, the ID is sequentially extracted from the analysis result in the ID-NAME converter (IDCV) (STEP 01), and then, the extracted ID is sent to the ID-NAME conversion table (IDNM) (STEP 02). Next, it is checked whether the extracted ID exists on the ID-NAME conversion table (IDNM) or not (STEP 03). If the ID exists, a corresponding individual name (for example, Thomas when the node ID in FIG. 5 is A) displayed on the ID-NAME conversion table (IDNM) is sent to the ID-NAME converter (IDCV), so that the conversion process is performed (STEP 04).

More specifically, the corresponding ID part of the structure information of the network diagram as illustrated in FIG. 4 is converted into the individual name. As a result, when the structure information of the network diagram after the conversion is browsed by a browser of the client PC (CL), the organization network diagram (NET-1) is displayed. Also, if the extracted ID does not exist on the ID-NAME conversion table (IDNM) in STEP 03, the conversion process is not performed, and the process is finished. By the above-described process, the organization network diagram (NET-0) using the node ID information can be converted into the organization network diagram (NET-1) using the individual name.

Next, with reference to FIG. 6B, a process of converting the organization network diagram (NET-0) using the node ID information into an organization network diagram (NET-2) using the individual name is described. In FIG. 6B, when node ID information (A, B, C, D, E, F, and G) of seven members in two teams (team 1 and team 2) is converted into individual names (Thomas, James, Emily, Parcy, Tobey, Sam, and Peter), respectively, structure information related to an unknown node ID which does not exist in the organization is deleted. The process is performed in the service gateway (SVG) in accordance with a process flow as illustrated in FIG. 6B.

Regarding a difference from the process in FIG. 6A, if the extracted ID does not exist (the ID information “X” in NET-0) on the ID-NAME conversion table (IDNM) in STEP 03, the non existence is noticed to the ID-NAME converter (IDCV), and the structure information (the coordinate information (POS), the attribution information (ATT), and the link connection matrix (LMAT)) corresponding to the ID information “X” is deleted (STEP 05).

When each member in a plurality of organizations wears the nameplate-type sensor node, it is assumed that they may face members who are not in the analyzing and displaying target organization but in the other organization. Even in this case, by the above-described process, influence of the case that the member in the corresponding organization faces an unknown nameplate-type sensor node (TR) can be removed, so that the understandable information for the user can be provided with focusing on only the corresponding organization. Further, influence of face-to-face error information due to noises or others can be removed.

Next, with reference to FIG. 6C, a process of converting the organization network diagram (NET-0) using the node ID information into an organization network diagram (NET-3) using the individual name is described. In FIG. 6C, node ID information of only a member in a team 1 of those (A, B, C, D, E, F, and G) of seven members in two teams (team 1 and team 2) is converted into the individual name. The process is performed in the service gateway (SVG) in accordance with a process flow as illustrated in FIG. 6C. Regarding a difference from the process in FIG. 6A, if the extracted ID exists on the ID-NAME conversion table (IDNM) in STEP 03, as a next process, it is determined whether the ID is set in a filtering target division or not (STEP 06), and if it corresponds to the filtering target division, the conversion process is not performed. By such a process, flexible management such that the browsing of detailed information of other team or other organization is limited becomes possible.

Last, with reference to FIG. 6D, a process of converting the organization network diagram (NET-0) using the node ID information into an organization network diagram (NET-4) using the individual name is described. In FIG. 6D, node ID information of only a member in a team 1 of seven members (A, B, C, D, E, F, and G) in two teams (team 1 and team 2) is converted into an individual name, and such a process that information of members in the other organization except for the team 1 is not displayed is performed. The process is performed in the service gateway (SVG) in accordance with a process flow as illustrated in FIG. 6D. Regarding a difference from the process in FIG. 6C, it is determined whether the ID is set in the filtering target division or not in STEP 06, and if it corresponds to the filtering target division, the structure information of the corresponding ID is deleted (STEP 05). By such a process, flexible management such that the member can browse with focusing on only information of a specific team or organization without displaying unnecessary information becomes possible.

Note that the application server may have functions of deleting the structure information and determining whether the ID corresponds to the filtering target division or not as described above. In this case, these functions are executed in the application server, the organization analysis result is sent to the service gateway, and the service gateway can only convert the ID into the name.

In the foregoing, as illustrated in FIGS. 6A to 6D, by the conversion process for the node ID information, risk such as private information leak can be prevented with dealing not the private information but the ID information in the service provider (SV).

Also, on the customer site (CS), by using the organization dynamics information with the converted individual name, the organization state can be understandably figured out.

Further, since the conversion process from the ID into the private information is performed in the service gateway (SVG), in the client PC (CL) for browsing the result, the result can be browsed by a general browser without installation of a special program or data distribution process. Therefore, even in a case of a large number of client PCs (CL), smooth introduction and management of the business microscope service becomes possible.

Still further, flexible management such that only the information of a specific team or organization is disclosed to its member becomes possible.

### Second Embodiment

A second embodiment of the present invention is described with reference to figures. The second embodiment has a feature of a method of forming an effective index matched with characteristics of a white-collar job in order to increase value of the organization analysis. For characteristics of the white-collar job having high productivity, both of increase of job performance of a member his/herself and advancement of further intellectual creation by communication among members are required. Accordingly, as characteristics of the white-collar job with a central focus on intellectual workers, there are two points of view of securement of time and environment for concentrating an individual job without interruption and of active attendance in a meeting or argument situation.

Accordingly, by combination of the face-to-face information and the acceleration information, a work quality of the organization is measured. More specifically, when one member is facing the other member, it is determined that the member actively communicates with the other if a magnitude of movement of the member is over a certain threshold value, and it is determined that the member inactively communicates with the other if the magnitude of the movement is equal to or less than the certain threshold value. Also, when the member is not facing the other, it is determined that the member is in a state that the member can concentrate the job without interruption (telephone or oral conversation) if the magnitude of the movement is equal to or less than the certain threshold value, and contrarily, it is determined that the member is in a state that the member cannot concentrate the job if the magnitude of the movement is over the certain threshold value.

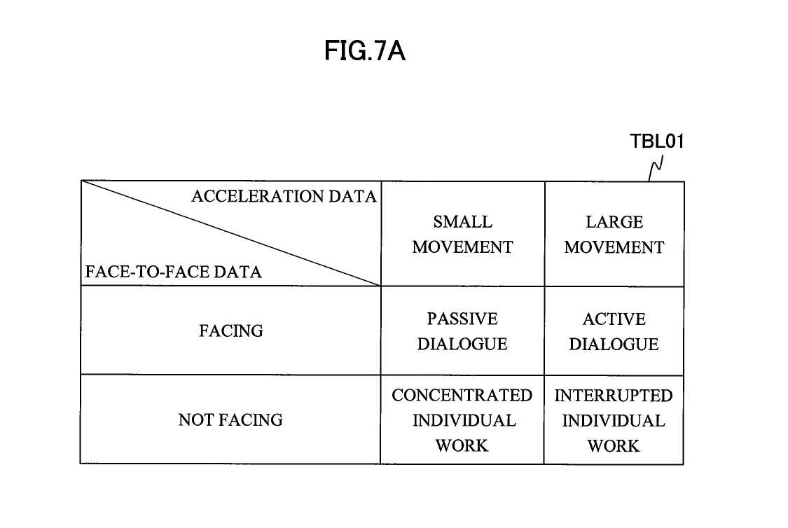

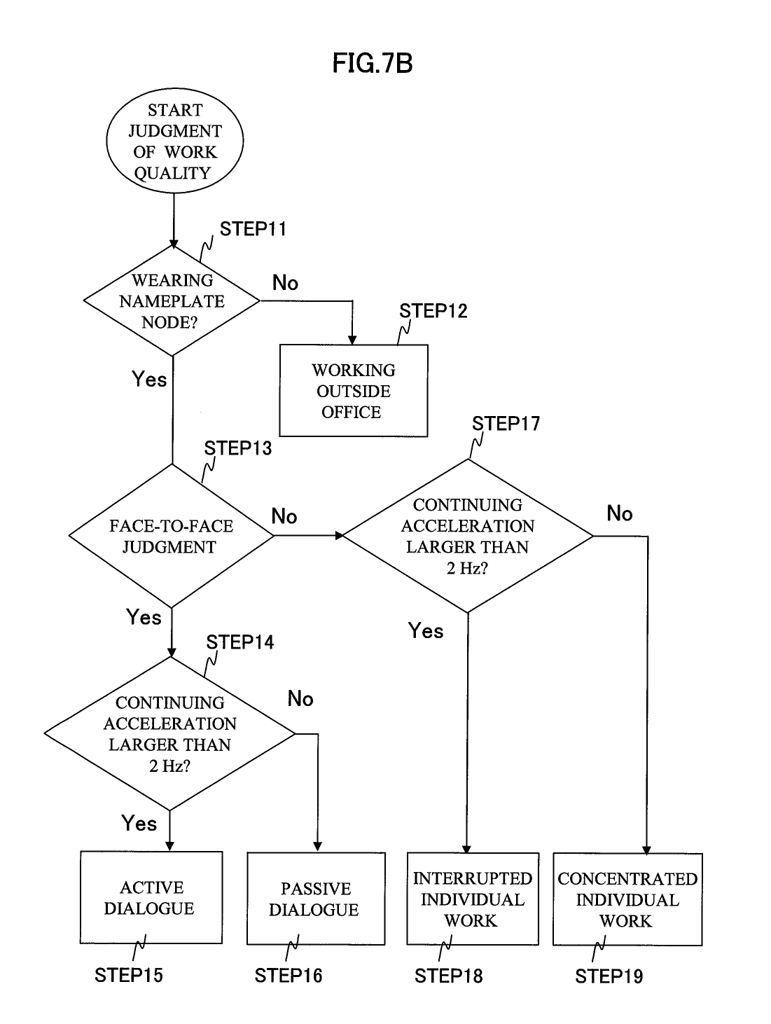

The work qualities organized in a table with using the sensor data are shown in FIG. 7A. In FIG. 7A, with using the acceleration data and the face-to-face data, when the member is facing the other member, that is in an argument or communication situation, it is determined that the member is taking passive dialogue if the movement is small (in a case that a result measured by the acceleration sensor is close to a static state), and it is determined that the member is taking the active dialogue if the movement is large (in a case that the magnitude of the movement corresponding to nodding or speaking is detected as the result measured by the acceleration sensor).

Also, when the member is not facing the other member, that is in a case that the member works the individual job, it is determined that the member is in the concentrating state or under an environment by which the member can concentrate if the movement is small (in the case that the result measured by the acceleration sensor is close to the static state), and it is determined that the member is in a state that the member cannot concentrate the individual job due to various interrupt factors such as the telephone conversation if the movement is large (in the case that the magnitude of the movement corresponding to nodding or speaking is detected as the result measured by the acceleration sensor).

With using a predetermined acceleration (for example, acceleration of 2 Hz) as the threshold value of the magnitude of the movement in order to identify either the small or large movement, work quality judgment flow is described below with reference to FIG. 7B.

First, working time of each member is divided into certain time slots, and, in each time slot, it is determined whether the member is wearing the nameplate node in the time or not (STEP 11). Whether the member is wearing or not can be determined by the illumination intensity acquired by the sensor node with using the illumination sensors (LS1F and LS1B). If the member is not wearing the nameplate node, it is determined that the member is working outside an office (STEP 12). If the member is wearing the nameplate node, face-to-face judgment is performed at the time (STEP 13).

If the face-to-face state is determined, it is determined whether a state of the magnitude of the acceleration larger than 2 Hz is continued for certain time or not (STEP 14). It is determined that the member is taking the active dialogue if the magnitude of the acceleration larger than 2 Hz is continued for certain time, (STEP 14), and it is determined that the member is taking the passive dialogue if the magnitude of the acceleration is equal to or smaller than 2 Hz (STEP 15).

Further, in STEP 13, if the member is not facing the other, it is determined whether the state of the magnitude of the acceleration larger than 2 Hz is continued for the certain time or not (STEP 17). It is determined that the individual job is interrupted (STEP 18) if the magnitude of the acceleration larger than 2 Hz is continued for the certain time, and it is determined that the member is concentrating the individual job if the magnitude of the acceleration is equal to or smaller than 2 Hz (STEP 19).

As described above, by the combination of the face-to-face information and the acceleration information, the individual work quality is measured. More specifically, it is determined whether the member is taking the active dialogue in the meeting or argument situation or not, or whether the member is concentrating the individual job or not. In this manner, the job performance of the member his/herself is increased and the communication among members is advanced, so that the further intellectual creation can be advanced.

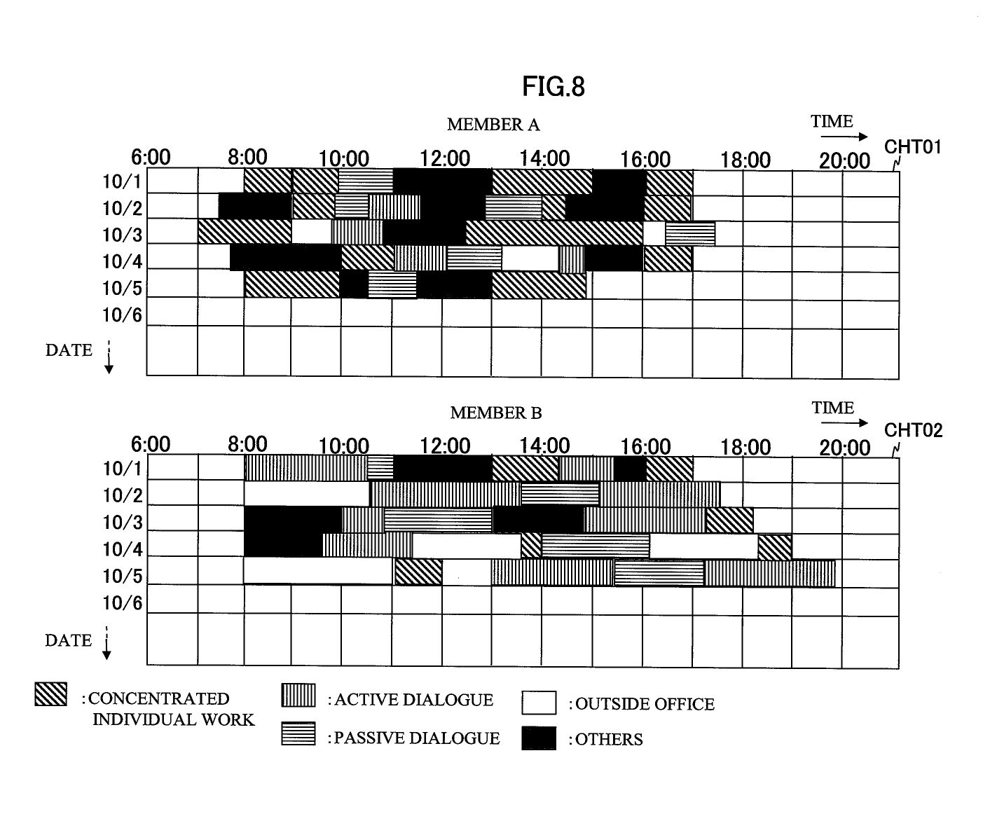

FIG. 8 illustrates these judgment results as a time-series chart. A result (CHT01) of a member “A” shows an example having a feature that the time of the concentrated individual job is long but the communication is passive, and a result (CHT02) of a member “B” shows an example having a feature that the active dialogue is taken but the time of the concentrated individual job is not so long. In this manner, by viewing the dialogue activeness and the degree of the concentrated individual job in a time axis, balance between the individual job and the mutual working (communication with the other member) can be figured out.

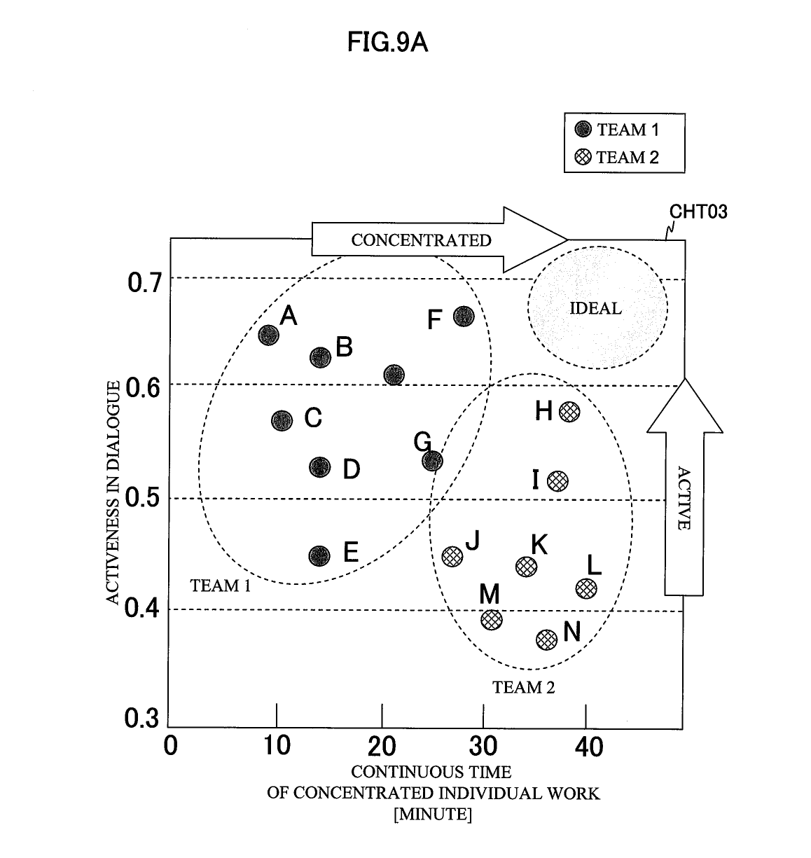

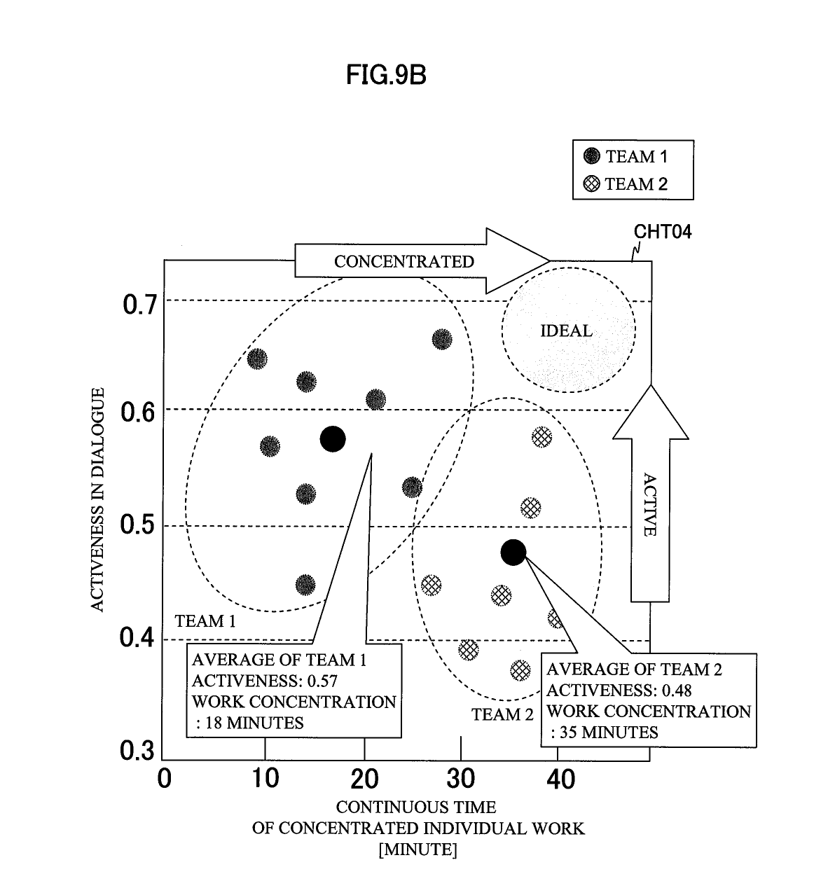

Further, FIG. 9A illustrates an example of a job balance chart (CHT03) foe the work quality of each member in two teams, which is mapped as taking the concentration time in a horizontal axis and the dialogue activeness in a vertical axis. In this example, the members in the team 1 have a tendency that the active communication is taken but the concentration is not continued, and the members in the team 2 have a tendency that the continuous concentration is long but the communication is not active.

By such a method of expressing the organization, the working balance of not only the individual but also the organization can be reviewed, actions for increasing the work quality with close to the ideal working can be implemented, and further, follow-up after the implementation of the actions can be appropriately performed.

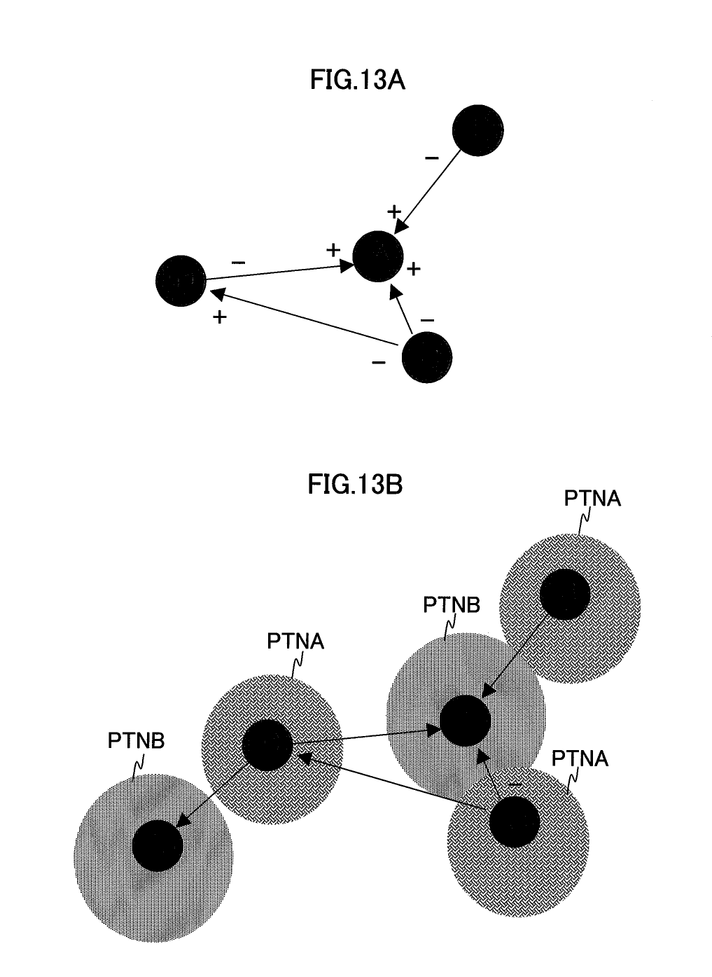

Also, volumes of the active dialogue and passive dialogue among members in the organization are measured for the certain time, so that relationship of each member with the other can be expressed. For example, in a communication between a member “A” and a member “B” as illustrated in FIG. 13A, if the activeness of the member A is higher than that of the member B, “+ (positive)” is expressed on the active member A, and “− (negative) ” is expressed on the passive member B on a link between them. By displaying the expression on a network diagram including other members, members having a tendency of the active dialogue (on whom the “+” expression is gathered) and members having a tendency of the passive dialogue (on whom the “−” expression is gathered) can be separated from each other. Further, as another expression method, as illustrated in FIG. 13B, a hatching of a pattern A (PTNA) is added to the member on whom the “+” expression is gathered and a hatching of another pattern B (PTNB) is added to the member on whom the “−” expression is gathered, so that it is determined that, for example, the member with the pattern A is a pitcher type (communication initiator) and the member with the pattern B is a catcher type (communication receiver), and therefore, dynamics of the communication flow can be further understandably displayed.

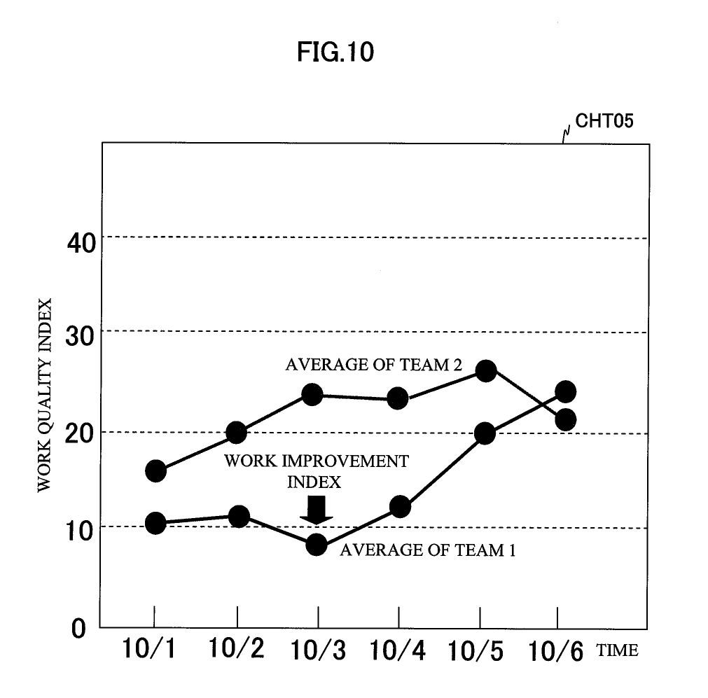

While FIG. 9A illustrates the example of visualizing the working tendency in the organization or team, an example of specifically defining the work quality of the organization as an index and monitoring the index in time series is described with reference to FIGS. 9B and 10. FIG. 9B illustrates a method of defining the index for ideally increasing both of the dialogue activeness and the continuous time of the concentrated individual job as the work quality of the team (CHT04). For example, one simple method of forming the index in consideration of both of the dialogue activeness and the continuous time of the concentrated individual job is to obtain each average value of the dialogue activeness and the continuous time of the concentrated individual job of the members in the team and use a product of both average values as the index of the work quality. In the example of FIG. 9B, when the average value of the activeness of the team 1 is 0.57 and the average value of the continuous time of the concentrated individual job is 18, 10.26 obtained by the product of them is the index of the team 1. Also, similarly, the index of the work quality of the team 2 is 16.8. These indexes are plotted in time series in FIG. 10 (CHT05).

The job quality of each team can be monitored by this expression method. For example, by visualizing the index expressing the characteristics of the white-collar job in time series, such as measurement of an effect when the job improvement action is implemented or comparison among the teams which cannot be conventionally visualized, the job productivity can be improved.

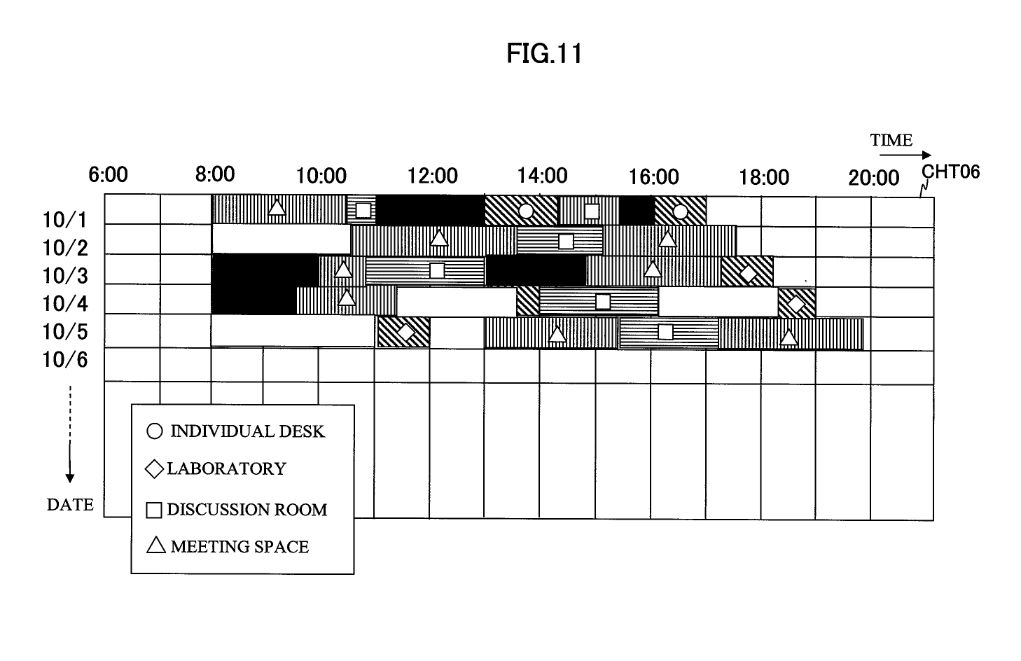

In the white-collar job, a space where the ability of the member in the organization can be fully used is important. Accordingly, definition of how the working place for the job distributes an activity of the member in the organization is necessary information for design of the working place or management thereof. Accordingly, FIG. 11 illustrates a job chart (CHT06) in which an icon corresponding to information of the place (such as an individual desk, laboratory, discussion room, and meeting space) where the job is performed is mapped, compared to the job chart for the members illustrated in FIG. 8. Note that, as a method of specifying the place where the member works, a node of transmitting infrared rays is installed on the space side similarly to the face-to-face situation among the members, and a name by which the space can be identified instead of the user may be assigned. Also, the place can be specified by a position of the base station communicated with the sensor node, and therefore, the method of specifying the place where the member works is not limited to the above-described method.

By such a visualized result, a space factor of easily causing the job concentration and the active communication can be defined, and it is possible to make a situation that the member in the organization easily fully uses the ability, so that the improvement of the white-collar job productivity can be achieved.

### Third Embodiment

A third embodiment of the present invention is described with reference to figures. In the third embodiment, a method of forming an index indicating the white-collar job productivity is described. More specifically, with using both of the sensor data and subjective individual assessment, an example of individual performance analysis is described.

As described above, in the performance input (C), subjective or objective assessment determined based on any standard is stored. For example, in the present embodiment, the subjective individual assessment about performances such as “Social”, “Intellectual”, “Spiritual”, “Physical”, and “Executive” is inputted in a certain interval. Here, rating on an about 10-point scales is periodically performed for questions such as, “whether good relationship (cooperation or sympathy) has been made or not” for the Social factor, “whether things to do have been done or not” for the Executive factor, “whether worthy or satisfaction has been felt to the job or not” for the Spiritual factor, “whether cares (rest, nutrition, and exercise) have been taken for the body or not” for the Physical factor, and “whether new intelligence (awareness or knowledge) has been obtained or not” for the Intellectual factor.

A performance related to the organization may be calculated from the individual performance. A previously-quantified data such as a questionnaire result from a customer or an objective data such as sales amount or a cost may be periodically inputted as the performance. When a numerical value such as an error incidence rate in manufacturing management or others can be automatically obtained, the obtained numerical value may be automatically inputted as the performance value. These performance results are stored in a performance table (BB).

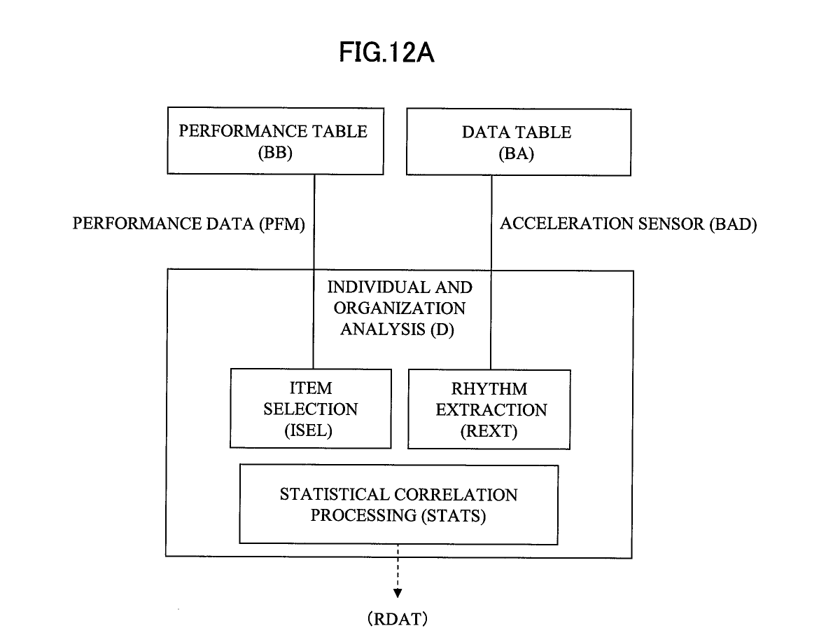

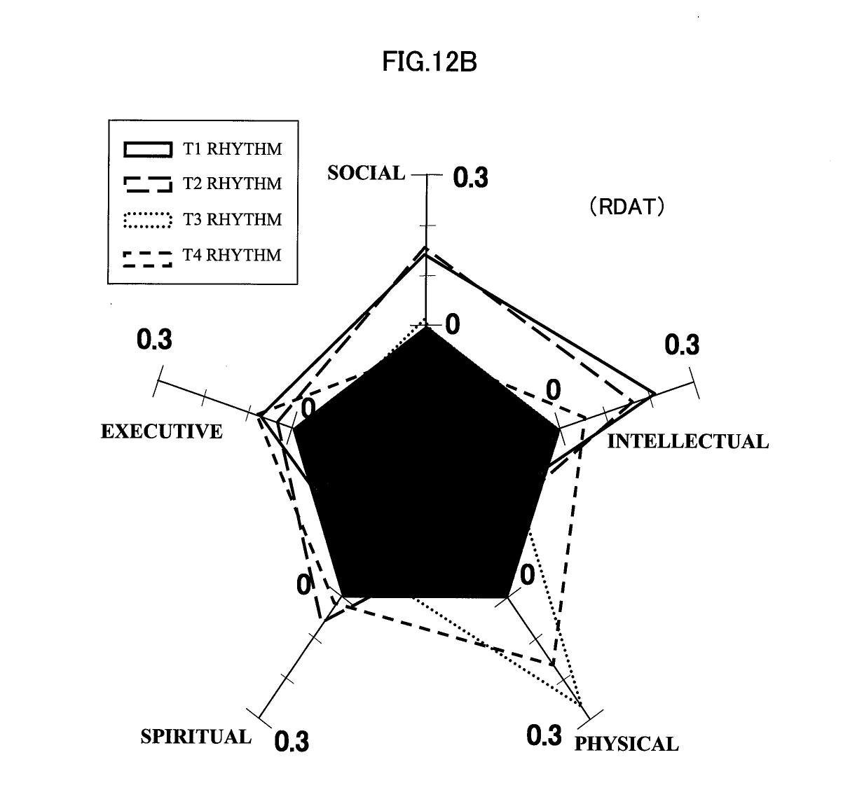

As illustrated in FIG. 12A, with using a performance data (PFM) stored in the performance table (BB) and an acceleration data (BAD) stored in the data table (BA), an example of the individual performance analysis is shown. When these performance data (PFM) and acceleration data (BAD) are inputted to an individual and organization analysis (D), processes of item selection (ISEL) and rhythm extraction (REXT) are performed for them, respectively. Here, the item selection selects an analysis-target performance of a plurality of performances. Also, the rhythm extraction extracts characteristic quantity (rhythm) such as a frequency (for example, 1 to 2 Hz) within a predetermined range obtained by the acceleration data. A statistical correlation processing (STAT) is performed for these time-series performance changes (the Social, the Executive, the Spiritual, the Physical, and the Intellectual) and time-series respective rhythm changes (for example, four types of the rhythm of T1 to T4), so that information indicating which performance is related to which rhythm is calculated.

FIG. 12B illustrates its calculation result as a radar chart (RDAT). In this expression method, a rhythm strongly related to each performance item is expressed outside a pentagon, a rhythm not related to the performance item is expressed in a periphery of the pentagon, and a rhythm negatively related to the performance item is expressed inside the pentagon.

Note that the subjective individual assessment is used for the performance in the above-described example. However, correlation between a behavioral factor and a subjective data such as a sales amount, cost, or process delay can be also calculated.

As described above, by forming the index indicating the white-collar job productivity with the combination of the sensor data and the performance, each individual can know the behavioral factor (rhythm) affecting the individual performance, so that the result can be helpful for behavioral improvement for the performance improvement or others.

In the second and third embodiments, the methods of forming the effective indexes indicating the white-collar job productivity have been described. As described in the first embodiment, by forming these indexes in the sensor-net server (SS) and/or the application server (AS) as the organization dynamics information not containing the private information and converting these indexes into the private information in the service gateway on the customer site, the organization dynamics information can be understandably provided.

In the foregoing, the embodiments of the present invention have been described. However, it is understandable by those who skilled in the art, that the present invention is not limited to the foregoing embodiments, various modifications can be made, and the above-described embodiments can be arbitrarily combined with each other.

### INDUSTRIAL APPLICABILITY

By acquiring a communication data of a person from a sensor worn on the person belonging to an organization and analyzing organization dynamics from the communication data, a service for providing an analysis result to the organization can be achieved.

1. A human behavior analysis system comprising:
a plurality of nodes;
a service gateway; and
a server of processing a sensor data sent from the plurality of nodes via the service gateway, wherein
the node includes: a sensor of acquiring the sensor data; and a first sending/receiving unit of sending the sensor data and node identification information to the service gateway,
the server includes: a controller of calculating an organization analysis data of an organization to which a user at each node belongs, based on the sensor data; and a second sending/receiving unit of sending the organization analysis data to the service gateway, and
the service gateway includes: a converter of converting the node identification information extracted from the organization analysis data into private information of the user, the converter being connected to the server via the Internet; and a third sending/receiving unit of outputting the organization analysis data containing the private information to a display device connected to the third sending/receiving unit itself.

2. The human behavior analysis system according to claim 1, wherein,
when a request is provided from the display device, the third sending/receiving unit sends the organization analysis data containing the private information.

3. The human behavior analysis system according to claim 1, wherein
the service gateway further includes a conversion table for correspondence of the node identification information and the private information.

4. The human behavior analysis system according to claim 1, wherein
an organization analysis data calculated by the controller contains a character string not containing the private information.

5. The human behavior analysis system according to claim 4, wherein
the service gateway includes a filtering policy of recording node identification information which is a conversion target into the private information, and
the converter controls the conversion of node identification information extracted from the organization analysis data into the private information in accordance with a registered content in the filtering policy.

6. A human behavior analysis system comprising:
a plurality of nodes; and
a server of processing a data sent from the plurality of nodes, wherein
the node includes: an infrared sensor of acquiring a face-to-face data with the other node; an acceleration sensor of acquiring an acceleration data; and a first sending/receiving unit of sending the face-to-face data and the acceleration data to the server, and
the server includes: a second sending/receiving unit of receiving the face-to-face data and the acceleration data; and a controller of measuring a work quality of a user using the face-to-face data and the acceleration data, from the node.

7. The human behavior analysis system according to claim 6, wherein,
when it is determined from the face-to-face data, that the user faces the other user, the controller measures dialogue activeness of the user from the acceleration data.

8. The human behavior analysis system according to claim 7, wherein,
when it is determined from the face-to-face data, that the user does not face the other user, the controller measures a degree of concentrated individual work of the user from the acceleration data.

9. The human behavior analysis system according to claim 8, wherein
the dialogue activeness and the degree of concentrated individual work are displayed in time series.

10. The human behavior analysis system according to claim 8, wherein,
on a plane of two coordinates as taking the dialogue activeness and continuous time of the concentrated individual work, a symbol corresponding to the user is plotted and displayed.

11. The human behavior analysis system according to claim 8, wherein
the controller calculates a work quality index of an organization to which a plurality of the users belong, with using a plurality of the dialogue activeness and a plurality of the degrees of concentrated individual works.

12. The human behavior analysis system according to claim 7, wherein
the controller measures dialogue activeness among the plurality of the users in a predetermined period, and categorizes a user having high degree of the dialogue activeness and a user having low degree of the dialogue activeness in an organization to which the plurality of the users belong.

13. The human behavior analysis system according to claim 12, wherein
the plurality of the users are represented by nodes on a face-to-face network, and a symbol corresponding to a result of the categorizing is added to the nodes and displayed.
